(19) United States
(12) Patent Application Publication
(10) Pub. No.: US 2026/0084408 A1
(43) Pub. Date: Mar. 26, 2026

(54) POSITIVE TONE LITHOGRAPHIC PRINTING PLATE PRECURSOR AND METHOD OF PREPARING LITHOGRAPHIC PRINTING PLATE

(71) Applicant: FUJIFILM Corporation, Tokyo (JP)

(72) Inventors: Atsushi Sugasaki, Shizuoka (JP); Natsumi Hirano, Shizuoka (JP); Kohei Aizu, Shizuoka (JP); Kyohei Takano, Shizuoka (JP)

(73) Assignee: FUJIFILM Corporation, Tokyo (JP)

(21) Appl. No.: 19/328,478

(22) Filed: Sep. 15, 2025

(30) Foreign Application Priority Data
Sep. 24, 2024 (JP) 2024-165664
Nov. 15, 2024 (JP) 2024-199974
Jan. 31, 2025 (JP) 2025-015280
Jun. 6, 2025 (JP) 2025-095099

(51) Int. Cl. B41C 1/10

(52) U.S. Cl. CPC B41C 1/1016; B41C 2201/04; B41C 2201/14; B41C 2210/02; B41C 2210/06; B41C 2210/22; B41C 2210/262

(57) ABSTRACT

A positive-working lithographic printing plate precursor including a support and an image-recording layer formed on the support and consisting of a positive-working photosensitive resin composition, in which the positive-working photosensitive resin composition contains a compound having at least one electron-withdrawing group and at least one phenolic hydroxyl group in one molecule, an alkali-soluble resin, and an infrared absorber, and the electron-withdrawing group excludes a sulfonyl group; and a method of preparing a lithographic printing plate using the positive-working lithographic printing plate precursor.

### CROSS-REFERENCE TO RELATED APPLICATIONS

This application claims priority from Japanese Patent Application No. 2024-165664, filed on Sep. 24, 2024, Japanese Patent Application No. 2024-199974, filed on Nov. 15, 2024, Japanese Patent Application No. 2025-015280, filed on Jan. 31, 2025, and Japanese Patent Application No. 2025-095099, filed on Jun. 6, 2025. Each of the above applications is hereby expressly incorporated by reference, in its entirety, into the present application.

### BACKGROUND OF THE INVENTION

### 1. Field of the Invention

The present disclosure relates to a positive-working lithographic printing plate precursor and a method of preparing a lithographic printing plate.

### 2. Description of the Related Art

In the related art, a variety of photosensitive compositions have been used as visible image forming materials or lithographic printing plate materials. In particular, the development of lasers in the field of lithographic printing has been remarkable in recent years, and in particular, high-output, compact solid-state lasers or semiconductor lasers with a light emission region from the near-infrared to infrared range have been readily available. In the field of lithographic printing, these lasers are extremely useful as exposure light sources in a case of directly carrying out plate making from digital data of a computer or the like.

A positive-working lithographic printing plate precursor for infrared laser contains an alkali-soluble resin in an image forming layer, an infrared absorber that absorbs light and generates heat (for example, an infrared absorbing dye, hereinafter also referred to as an IR dye), and the like.

In a non-exposed portion, the infrared absorber, particularly the IR dye or the like, acts as a development inhibitor which substantially reduces the solubility of a resin in a developer through the interaction with the resin, so the non-exposed portion serves as an image area of a lithographic printing plate. In addition, in an exposed portion, the interaction between the IR dye or the like and the resin is weakened by the generated heat, causing the resin to dissolve in the developer, so the exposed portion serves as a non-image area, resulting in the formation of a lithographic printing plate.

In the positive-working lithographic printing plate precursor, the greater the difference in solubility in an alkaline developer between a portion exposed to an infrared laser and a portion not exposed to an infrared laser, the better the image formability is evaluated to be.

As the positive-working lithographic printing plate precursor in the related art, those described in JP2004-287001A and JP4081491B are known. JP2004-287001A describes a lithographic printing plate precursor including two image-recording layers on a support, in which the first layer, that is, the lower layer contains a first resin that is water-insoluble and alkali-soluble, and the second layer, that is, the upper layer contains a second resin that is water-insoluble and alkali-soluble and contains a phenolic hydroxyl group, a photothermal conversion agent, and a group of compounds having a molecular weight of 800 or less, which contains at least one substituent such as a carboxylic acid group or a phenolic hydroxyl group that suppresses the dissolution of the second resin, and which is said to have a large difference in developability between an exposed portion and a non-exposed portion.

JP4081491B describes a positive-working photosensitive composition which contains an alkali-soluble organic polymer substance having a phenolic hydroxyl group, a photothermal conversion substance, at least one selected from a specific resin, and a dissolution inhibitor that is a low-molecular-weight compound having three phenolic hydroxyl groups, and which is said to have good alkali development resistance of a non-exposed portion.

### SUMMARY OF THE INVENTION

The performance required for a positive-working lithographic printing plate precursor includes a good difference in alkali developability between an exposed portion and a non-exposed portion, that is, good development discrimination. In addition, the performance required for a positive-working lithographic printing plate precursor includes good printing durability and scratch resistance of the image area of the obtained lithographic printing plate.

Here, in the positive-working lithographic printing plate precursor, reducing the solubility of an image area in an alkaline developer to improve printing durability, that is, to form a firm image area and obtaining good alkali developability in a non-image area are properties that are contrary to each other, and it is considered difficult to achieve both of them at the same time.

An object to be achieved by one embodiment of the present disclosure is to provide a positive-working lithographic printing plate precursor that has good development discrimination and provides good printing durability of a lithographic printing plate to be obtained and good scratch resistance of an image area.

An object to be achieved by another embodiment of the present disclosure is to provide a method of preparing a lithographic printing plate that has good printing durability and exhibits good developability of a non-image area.

The means for achieving the above-mentioned objects include the following aspects.
<1> A positive-working lithographic printing plate precursor comprising: a support; and an image-recording layer provided on the support and consisting of a positive-working photosensitive resin composition, in which the positive-working photosensitive resin composition contains a compound having at least one electron-withdrawing group and at least one phenolic hydroxyl group in one molecule, an alkali-soluble resin, and an infrared absorber, and the electron-withdrawing group excludes a sulfonyl group.
<2> The positive-working lithographic printing plate precursor according to <1>, in which the electron-withdrawing group is at least one selected from the group consisting of a halogen atom, a trifluoromethyl group, a nitro group, a cyano group, an alkoxycarbonyl group, an acyloxy group, an amide group, and an alkylcarbonyl group.
<3> The positive-working lithographic printing plate precursor according to <1> or <2>, in which the compound having at least one electron-withdrawing group and at least one phenolic hydroxyl group in one molecule has two or more phenolic hydroxyl groups in one molecule.
<4> The positive-working lithographic printing plate precursor according to <1> or <2>, in which the compound having at least one electron-withdrawing group and at least one phenolic hydroxyl group in one molecule has three or more phenolic hydroxyl groups in one molecule.
<5> The positive-working lithographic printing plate precursor according to any one of <1> to <3>, in which the electron-withdrawing group is an alkoxycarbonyl group or an alkylcarbonyl group.
<6> The positive-working lithographic printing plate precursor according to any one of <1> to <5>, in which the compound having at least one electron-withdrawing group and at least one phenolic hydroxyl group in one molecule includes at least one selected from the group consisting of a gallic acid ester compound and a compound having a plurality of gallic acid ester moieties in the same molecule.
<7> The positive-working lithographic printing plate precursor according to any one of <1> to <6>, in which the compound having at least one electron-withdrawing group and at least one phenolic hydroxyl group in one molecule is a gallic acid ester compound.
<8> A positive-working lithographic printing plate precursor comprising: a support; and an image-recording layer provided on the support, in which the image-recording layer has a lower layer and an upper layer in this order from a support side, and at least one of the lower layer or the upper layer consists of a positive-working photosensitive resin composition, in which the positive-working photosensitive resin composition contains a compound having at least one electron-withdrawing group and at least one phenolic hydroxyl group in one molecule, an alkali-soluble resin, and an infrared absorber, and the electron-withdrawing group excludes a sulfonyl group.
<9> The positive-working lithographic printing plate precursor according to <8>, further comprising an undercoat layer between the support and the image-recording layer.
<10> The positive-working lithographic printing plate precursor according to <8> or <9>, in which the lower layer consists of the positive-working photosensitive resin composition, and the alkali-soluble resin contained in the lower layer includes at least one selected from an acrylic resin having a sulfonamide group in a side chain, an acrylic resin having a phenolic hydroxyl group in a side chain, or a novolac resin.
<11> The positive-working lithographic printing plate precursor according to any one of <8> to <10>, in which the upper layer consists of the positive-working photosensitive resin composition, the upper layer contains an infrared absorber and a water-insoluble, alkali-soluble resin, the water-insoluble, alkali-soluble resin is at least one selected from the group consisting of a polyamide resin, an epoxy resin, a polyacetal resin, an acrylic resin, a methacrylic resin, a polystyrene-based resin, and a novolac-type phenolic resin, and an interaction is formed between a polar group contained in the water-insoluble, alkali-soluble resin and the infrared absorber.
<12> The positive-working lithographic printing plate precursor according to <9>, in which the undercoat layer contains at least one selected from the group consisting of a phosphonic acid having an amino group, an organic phosphonic acid, an organic phosphoric acid, an organic phosphinic acid, an amino acid, and a hydrochloride of an amine having a hydroxy group.
<13> The positive-working lithographic printing plate precursor according to any one of <8> to <12>, in which the upper layer further contains a polymer having a unit having a fluorinated alkyl group in a side chain.
<14> The positive-working lithographic printing plate precursor according to any one of <8> to <12>, in which at least one of the upper layer or the lower layer contains a polymer having a unit represented by Formula (I).

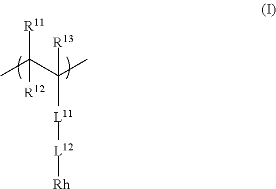

In Formula (I), R¹¹ and R¹² each independently represent a hydrogen atom or an alkyl group, R¹³ represents a hydrogen atom or a monovalent substituent, L¹¹ and L¹² each independently represent a single bond or a divalent linking group, and Rh represents a substituent containing two or more silicon atoms.
<15> The positive-working lithographic printing plate precursor according to any one of <8> to <14>, in which the upper layer contains the polymer having a unit represented by Formula (I).
<16> A method of preparing a lithographic printing plate, comprising, in the following order: imagewise exposing the positive-working lithographic printing plate precursor according to any one of <1> to <7>; and developing the exposed positive-working lithographic printing plate precursor with an alkali aqueous solution having a pH of 8.5 to 13.5.
<17> A method of preparing a lithographic printing plate, comprising, in the following order: imagewise exposing the positive-working lithographic printing plate precursor according to any one of <8> to <15>; and developing the exposed positive-working lithographic printing plate precursor with an alkali aqueous solution having a pH of 8.5 to 13.5.

According to one embodiment of the present disclosure, there is provided a positive-working lithographic printing plate precursor that has good development discrimination and provides good printing durability of a lithographic printing plate to be obtained and good scratch resistance of an image area.

According to another embodiment of the present disclosure, there is provided a method of preparing a lithographic printing plate that has good printing durability and exhibits good developability of a non-image area.

### DESCRIPTION OF THE PREFERRED EMBODIMENTS

Hereinafter, the contents of the present disclosure will be described in more detail. The description of configuration requirements described below may be made on representative embodiments of the present disclosure, but the present disclosure is not limited to such embodiments.

In the present disclosure, a term “to” indicating a numerical range is used as a meaning including numerical values described before and after the term “to” as a lower limit value and an upper limit value, respectively.

In addition, in the present disclosure, in a case where there is no description regarding whether a group (atomic group) is substituted or unsubstituted, such a group includes both a group having no substituent and a group having a substituent. For example, an “alkyl group” includes not only an alkyl group having no substituent (unsubstituted alkyl group), but also an alkyl group having a substituent (substituted alkyl group).

In addition, in the present disclosure, “% by mass” and “% by weight” are synonymous, and “parts by mass” and “parts by weight” are synonymous.

In the present disclosure, the solid content contained in a composition refers to a mass excluding a volatile component such as a solvent. For example, a low-molecular-weight monomer and the like are included in the solid content even in a case of being liquid components.

In the present disclosure, the term “step” not only includes an independent step, but also includes a step that may not be clearly distinguished from the other step but still achieves a desired effect of the step.

In the present disclosure, combinations of preferred aspects are more preferred aspects.

In the present disclosure, unless otherwise specified, the molecular weight of a polymer component is a weight-average molecular weight (Mw) or a number-average molecular weight (Mn) in terms of polystyrene measured by gel permeation chromatography (GPC) in a case where tetrahydrofuran (THF) is used as a solvent.

### Positive-Working Lithographic Printing Plate Precursor

The positive-working lithographic printing plate precursor according to the present disclosure is a positive-working lithographic printing plate precursor including a support and an image-recording layer formed on the support and consisting of a positive-working photosensitive resin composition, in which the positive-working photosensitive resin composition contains a compound having at least one electron-withdrawing group and at least one phenolic hydroxyl group in one molecule, an alkali-soluble resin, and an infrared absorber, and the electron-withdrawing group excludes a sulfonyl group.

The above-mentioned electron-withdrawing group is preferably at least one selected from the group consisting of a halogen atom, a trifluoromethyl group, a nitro group, a cyano group, an alkoxycarbonyl group, an acyloxy group, an amide group, and an alkylcarbonyl group.

Examples of the halogen atom include a chloro group, a bromo group, a fluoro group, and an iodo group.

Hereinafter, in the present disclosure, the compound having at least one electron-withdrawing group and at least one phenolic hydroxyl group in one molecule is also referred to as a “specific compound”.

As a result of extensive studies, the present inventors have found that, in a case where the positive-working photosensitive resin composition contained in the image-recording layer in the positive-working lithographic printing plate precursor according to the present disclosure contains the above-mentioned specific compound, this results in good development discrimination, and good printing durability of a lithographic printing plate to be obtained and good scratch resistance of an image area.

In the present disclosure, the term “image-recording layer consisting of a positive-working photosensitive resin composition” refers to a layer consisting of a dried product of a positive-working photosensitive resin composition. The dried product of a positive-working photosensitive resin composition may be obtained by using a drying instrument or may be obtained by natural drying.

Although the detailed mechanism by which the above-mentioned effects are obtained is not clear, it is speculated as follows.

Since the specific compound contained in the image-recording layer of the positive-working lithographic printing plate precursor according to the present disclosure has a phenolic hydroxyl group in the molecule thereof, a pseudo-crosslinked structure is formed between the specific compound and the alkali-soluble resin coexisting therewith through multi-point hydrogen bonds. Therefore, the penetration of the alkaline developer into the image-recording layer and the neutralization thereof are suppressed in the non-exposed portion. On the other hand, in the exposed portion, in a case where the above-mentioned multi-point hydrogen bonds are released, the characteristic that the acidity (pKa) of the molecule is low due to the presence of the electron-withdrawing group and the phenolic hydroxyl group originally contained in the specific compound is exhibited, and thus the specific compound functions as an alkali dissolution promoter.

Therefore, it is considered that the specific compound has a development suppressing effect in a non-exposed portion and exhibits a development promoting effect in an exposed portion, thus resulting in good development discrimination. Further, it is considered that since there is a strong interaction between the phenolic hydroxyl group and the alkali-soluble resin in the non-exposed portion, a lithographic printing plate having excellent printing durability can be obtained. It is considered that the above-mentioned tendency is further improved by a large number of phenolic hydroxyl groups, a low molecular weight of the specific compound, and the like.

It should be noted that the above mechanism is a presumed mechanism and does not limit the present disclosure in any way.

The positive-working photosensitive resin composition that forms the image-recording layer of the positive-working lithographic printing plate precursor according to the present disclosure is also simply referred to as the positive-working photosensitive resin composition of the present disclosure.

Hereinafter, each component contained in the positive-working photosensitive resin composition of the present disclosure will be described in more detail.

### Specific Compound

The positive-working photosensitive resin composition contains a compound having at least one electron-withdrawing group and at least one phenolic hydroxyl group in one molecule, that is, a specific compound.

The phenolic hydroxyl group may be any hydroxyl group bonded to an aromatic ring and may be, for example, a hydroxyl group bonded to a benzene ring or a hydroxyl group bonded to a naphthalene ring in which two or more aromatic rings are fused.

From the viewpoint of obtaining better development discrimination with respect to an alkaline developer and better printing durability of the obtained image area, the specific compound is preferably a compound having two or more phenolic hydroxyl groups in one molecule and more preferably a compound having three or more phenolic hydroxyl groups in one molecule.

The compound having two or more phenolic hydroxyl groups in one molecule refers to a compound having two or more hydroxyl groups directly bonded to one aromatic ring.

The electron-withdrawing group contained in the specific compound is preferably at least one selected from the group consisting of a halogen atom, a trifluoromethyl group, a nitro group, a cyano group, an alkoxycarbonyl group, an acyloxy group, an amide group, and an alkylcarbonyl group, excluding a sulfonyl group, and these are hereinafter referred to as a specific electron-withdrawing group. Here, examples of the halogen atom include a chloro group, a bromo group, a fluoro group, and an iodo group.

The specific electron-withdrawing group is more preferably at least one selected from the group consisting of a chloro group, a bromo group, a trifluoromethyl group, a nitro group, a cyano group, an alkoxycarbonyl group, an acyloxy group, an amide group, and an alkylcarbonyl group.

Furthermore, among the specific electron-withdrawing groups, the specific electron-withdrawing group in the specific compound according to the present disclosure is still more preferably an alkoxycarbonyl group or an alkylcarbonyl group, from the viewpoint of more easily promoting the alkali developability of the exposed portion.

The specific compound may have only one electron-withdrawing group, or may have two or more electron-withdrawing groups. In a case where the specific compound has two or more electron-withdrawing groups in one molecule, the electron-withdrawing groups may be the same as or different from each other, and from the viewpoint of maintaining good solubility in an application solvent used in a case of preparing a lithographic printing plate, it is preferable that the electron-withdrawing groups are different from each other.

Specific examples of the specific compound are shown below, but the specific compound is not limited to the following specific examples.

Specific examples of specific compounds having one phenolic hydroxyl group and one electron-withdrawing group in molecule: specific compound group i

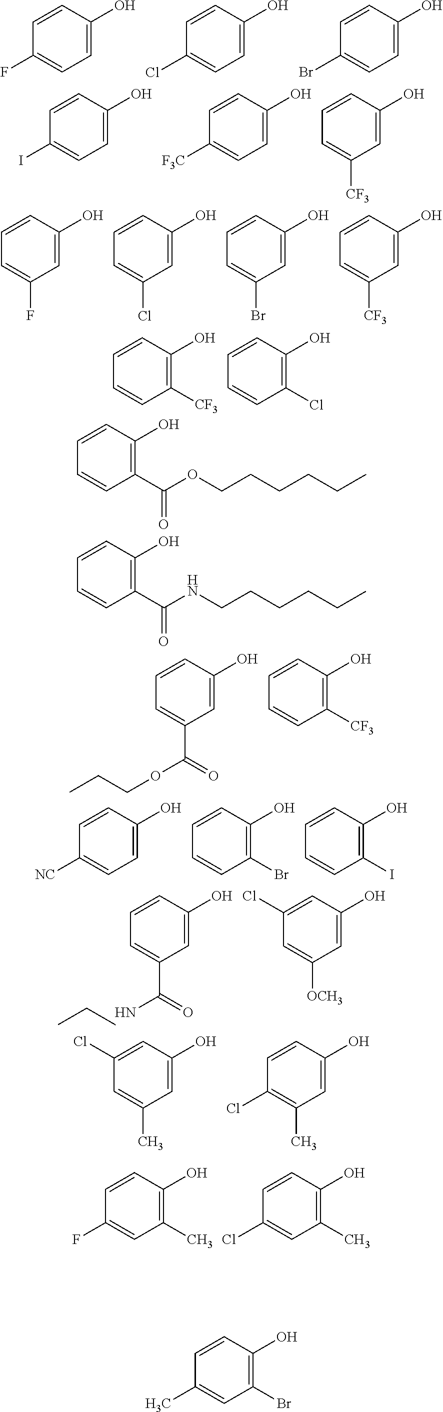

Specific examples of specific compounds having one phenolic hydroxyl group and two or more electron-withdrawing groups in molecule: specific compound group ii

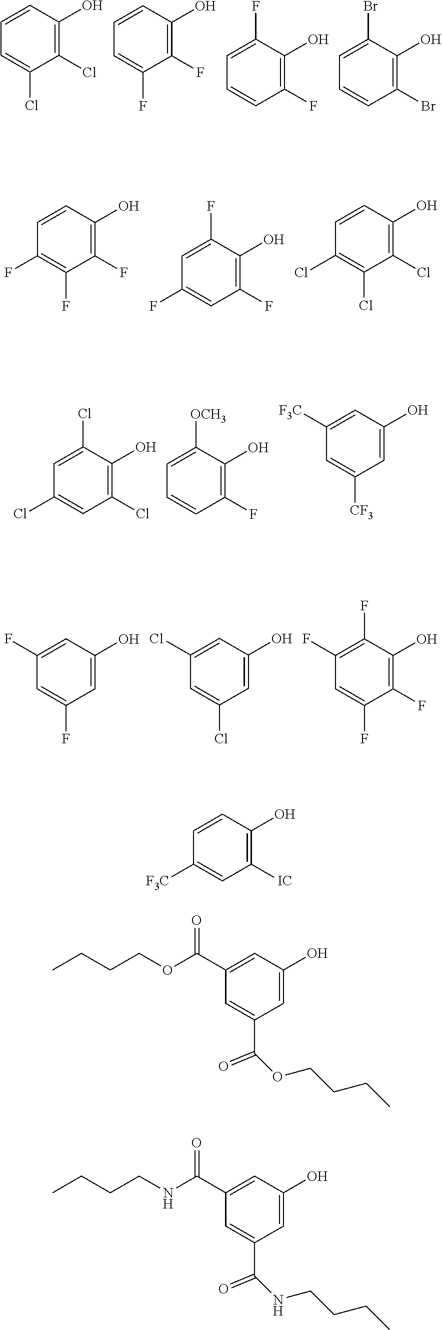

Specific examples of specific compounds having one or two phenolic hydroxyl groups and one or two electron-withdrawing groups in naphthalene ring: specific compound group iii

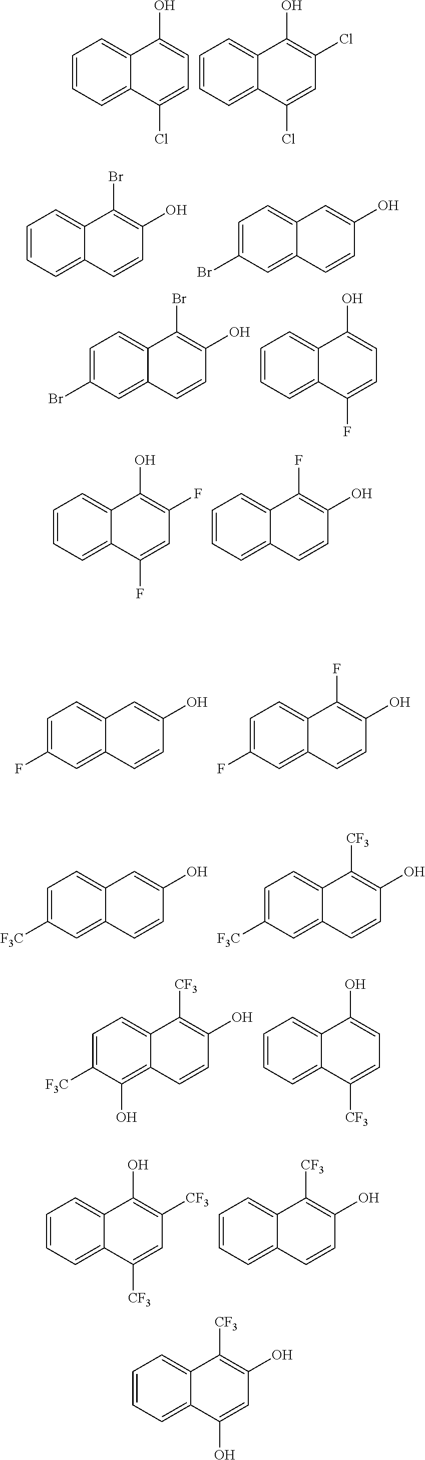

Specific examples of specific compounds having two phenolic hydroxyl groups and one or two or more electron-withdrawing groups: specific compound group iv

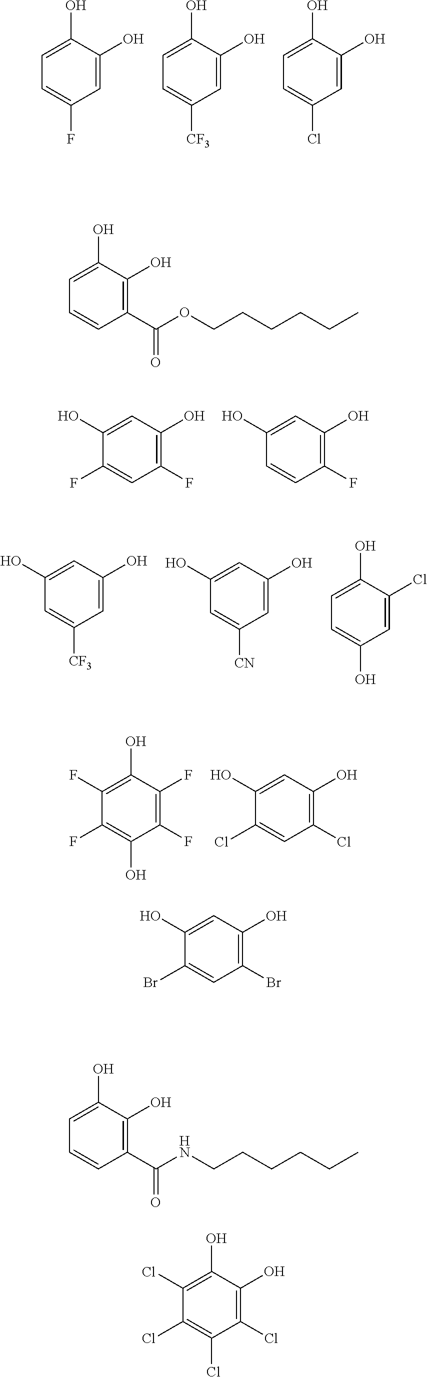

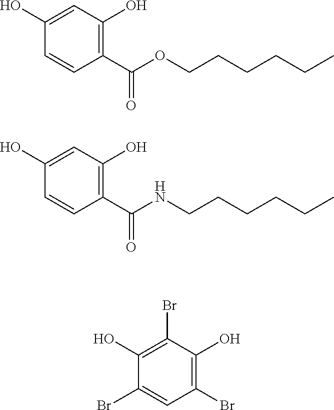

Specific examples of specific compounds having three or more phenolic hydroxyl groups and one or two electron-withdrawing groups: specific compound group v

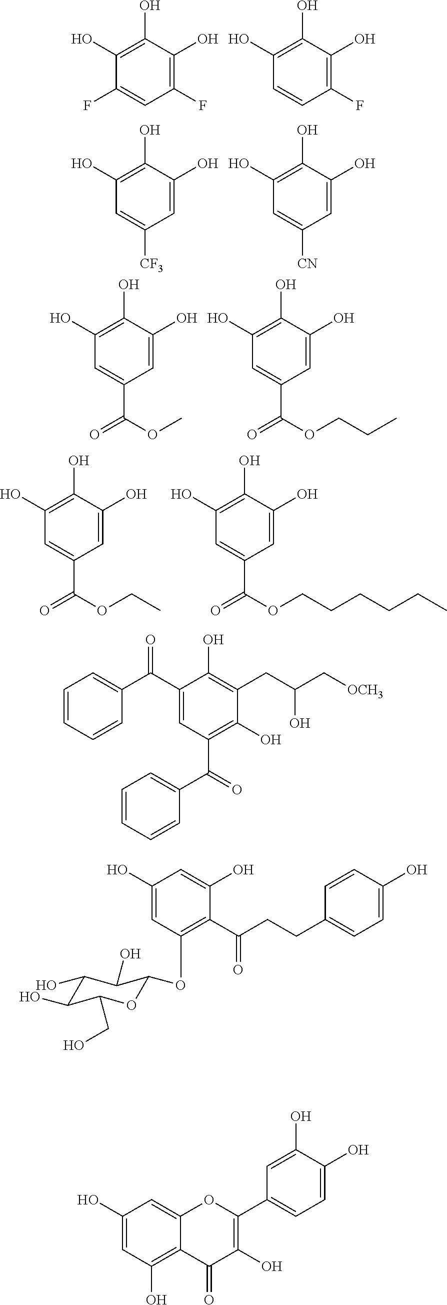

All of the above specific examples are examples in which one benzene ring or one naphthalene ring has one or more phenolic hydroxyl groups and one or more specific electron-withdrawing groups, but the specific compound is not limited to the above examples, and may be a compound having a plurality of aromatic rings each having a phenolic hydroxyl group and a specific electron-withdrawing group in the molecule thereof. In a case where the specific compound has a plurality of aromatic rings each having a phenolic hydroxyl group and a specific electron-withdrawing group in the molecule thereof, alkali development resistance may be exhibited due to stronger multi-point hydrogen bonds.

Specific examples of the specific compound having a plurality of aromatic rings each having a phenolic hydroxyl group and a specific electron-withdrawing group are shown below.

Specific examples of specific compounds having plurality of aromatic rings each having phenolic hydroxyl group and specific electron-withdrawing group: specific compound group vi

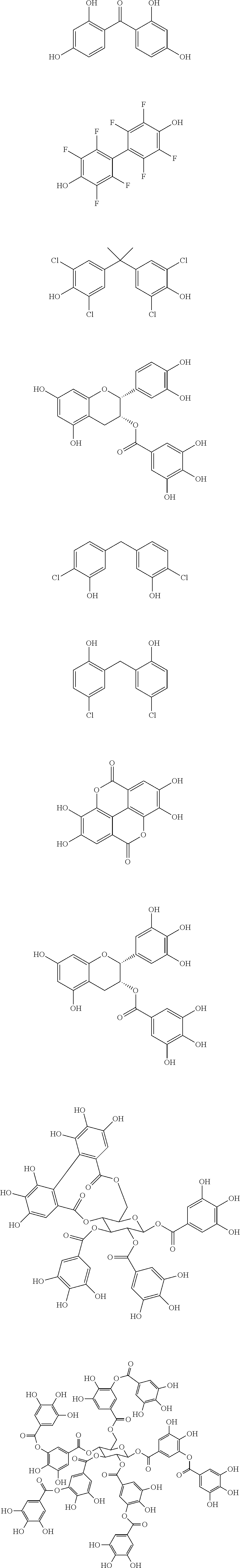

Among the above, the specific compound preferably includes a compound selected from a gallic acid ester compound belonging to the specific compound group i and a compound having a plurality of gallic acid ester moieties in the same molecule, and more preferably includes a gallic acid ester compound represented by the following structure.

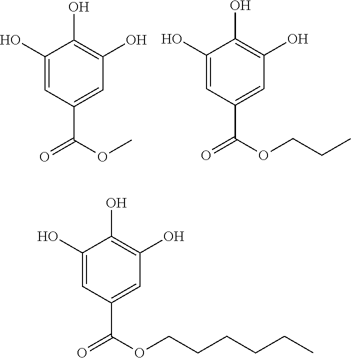

The positive-working photosensitive resin composition may contain one type of specific compound alone, or may contain two or more types of specific compounds.

From the viewpoint of obtaining better development discrimination of a lithographic printing plate precursor and better printing durability of a lithographic printing plate to be obtained, the content of the specific compound is preferably in a range of 0.05% by mass to 30% by mass and more preferably in a range of 0.5% by mass to 15% by mass with respect to the total solid content of the positive-working photosensitive resin composition.

### Alkali-Soluble Resin

The positive-working photosensitive resin composition contains an alkali-soluble resin.

In the present disclosure, the expression that the resin is “alkali-soluble” means that 0.01 g of the resin dissolves in 5 g of a sodium hydroxide aqueous solution at 30° C. and a pH of 13.0 within 200 seconds. The dissolution refers to a state in which no remaining dissolved matter is visually confirmed.

Examples of the alkali-soluble resin include an acrylic resin, a novolac resin, a polyurea, a polyurethane, and a polycarbonate.

From the viewpoint of further improving development discrimination and printing durability, the alkali-soluble resin is preferably an acrylic resin or a novolac resin.

Hereinafter, preferred aspects of the alkali-soluble resin according to the present disclosure will be described.

### Acrylic Resin

As the alkali-soluble resin, for example, any compound known in the field of positive-working lithographic printing plate precursors can be used without particular limitation. Preferred examples of the alkali-soluble resin include the water-insoluble, alkali-soluble resins described in paragraphs to of JP2008-151929A.

Above all, an acrylic resin having a sulfonamide group in a side chain or an acrylic resin having a phenolic hydroxyl group in a side chain is preferable.

### Acrylic Resin Having Sulfonamide Group in Side Chain

Examples of the acrylic resin having a sulfonamide group in a side chain include a copolymer containing a monomer unit formed of a monomer having a sulfonamide group.

The monomer having a sulfonamide group is not particularly limited and examples thereof include a (meth)acrylamide compound having a sulfonamide group, a (meth)acrylic acid ester compound having a sulfonamide group, and a styrene compound having a sulfonamide group.

Specific examples of the monomer having a sulfonamide group include N-(p-toluenesulfonyl) acrylamide and N-(p-toluenesulfonyl) methacrylamide.

The copolymer may further contain a monomer unit formed of other monomers, and examples of the other monomers include a (meth)acrylic acid ester compound, a (meth)acrylamide compound, an acrylonitrile compound, and a styrene compound, each of which is known. The monomers described in paragraphs and of JP2008-151929A can also be suitably used.

In the present disclosure, the description of the (meth)acrylic acid ester compound or the like refers to an acrylic acid ester compound or a methacrylic acid ester compound, or the like.

### Acrylic Resin Having Phenolic Hydroxyl Group in Side Chain

Examples of the acrylic resin having a phenolic hydroxyl group in a side chain include a copolymer containing a monomer unit formed of a monomer having a phenolic hydroxyl group.

The monomer having a phenolic hydroxyl group is not particularly limited and examples thereof include a (meth)acrylamide compound having a phenolic hydroxyl group, a (meth)acrylic acid ester compound having a phenolic hydroxyl group, and a hydroxystyrene compound having a phenolic hydroxyl group. Specifically, N-(2-hydroxyphenyl) acrylamide, N-(3-hydroxyphenyl) acrylamide, N-(4-hydroxyphenyl) acrylamide, N-(2-hydroxyphenyl) methacrylamide, N-(3-hydroxyphenyl) methacrylamide, N-(4-hydroxyphenyl) methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate, 2-(4-hydroxyphenyl)ethyl methacrylate, and the like can be suitably used.

The copolymer of the acrylic resin having a sulfonamide group in a side chain and the acrylic resin having a phenolic hydroxyl group in a side chain may further contain a monomer unit formed of other monomers, and examples of the other monomers include a (meth)acrylic acid ester compound, an acrylonitrile compound, an allyl cyanide compound, and a styrene compound, each of which is known. The monomers described in paragraphs and of JP2008-151929A can also be suitably used.

The weight-average molecular weight of the acrylic resin having a sulfonamide group in a side chain or the acrylic resin having a phenolic hydroxyl group in a side chain is preferably more than 5,000 and 300,000 or less and more preferably 10,000 to 200,000.

Specific examples of the acrylic resin having a sulfonamide group in a side chain and the acrylic resin having a phenolic hydroxyl group in a side chain are shown below, but the present invention is not limited thereto. In the specific examples shown below, a subscript in parenthesis indicating a monomer unit represents a content (% by mole) of each monomer unit, Me represents a methyl group, and Ph represents a phenyl group.

| | | | | |
|---|---|---|---|---|
| PA-1 | 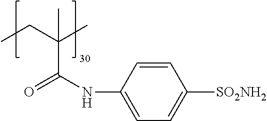 | 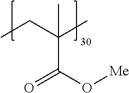 | 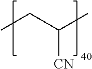 | Mw 45,000 |
| PA-2 | 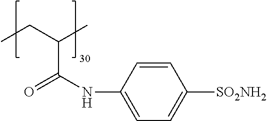 | 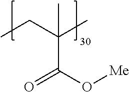 | 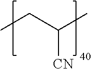 | Mw 51,000 |
| PA-3 | 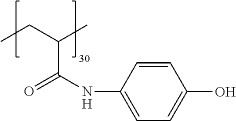 | 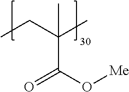 | 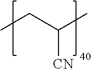 | Mw 43,000 |

| | | | | | |
|---|---|---|---|---|---|
| PA-4 | 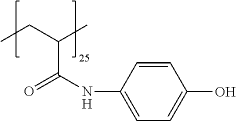 | 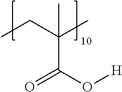 | 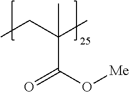 | 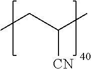 | Mw 41,000 |
| PA-5 | 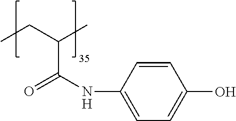 | 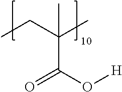 | 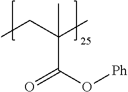 | 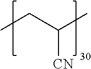 | Mw 48,000 |

| | | | | |
|---|---|---|---|---|
| PA-6 | 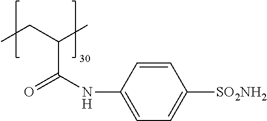 | 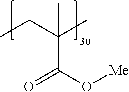 | 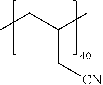 | Mw 55,000 |

### Polyurea, Polyurethane, and Polycarbonate

In addition, a polyurea, a polyurethane, or a polycarbonate can also be suitably used as the alkali-soluble resin.

The polyurea, the polyurethane, or the polycarbonate preferably has an acid group, and from the viewpoint of printing durability and developability, the polyurea, the polyurethane, or the polycarbonate more preferably has a sulfonamide group in a main chain.

It is preferable that the polyurea, the polyurethane, or the polycarbonate has other acid groups in a side chain. The acid group in a side chain is preferably a phenolic hydroxyl group, a sulfonamide group, or a carboxy group.

Examples of these alkali-soluble resins include the compounds described in paragraphs to of JP2018-165797A, and the description thereof can be referred to in the present disclosure.

### Novolac Resin

### Preferred Examples of the Alkali-Soluble Resin Also Include a Novolac Resin

Preferred examples of the novolac resin that can be used in the positive-working photosensitive resin composition according to the present disclosure include a novolac resin such as a phenol formaldehyde resin, an m-cresol formaldehyde resin, a p-cresol formaldehyde resin, an m-/p-mixed cresol formaldehyde resin, or a phenol/cresol (which may be any of m-, p-, or m-/p-mixed) mixed formaldehyde resin, and a pyrogallol acetone resin.

Furthermore, examples of the novolac resin also include a phenol-formaldehyde condensation polymer having an alkyl group having 3 to 8 carbon atoms as a substituent, such as a t-butylphenol formaldehyde resin and an octylphenol formaldehyde resin, as described in U.S. Pat. No. 4,123,279A. In addition, the weight-average molecular weight (Mw) of the novolac resin is preferably 500 or more and more preferably 1,000 to 700,000. In addition, the number-average molecular weight (Mn) of the novolac resin is preferably 500 or more and more preferably 750 to 650,000. The dispersity (weight-average molecular weight/number-average molecular weight) of the novolac resin is preferably 1.1 to 10.

The alkali-soluble resin is not particularly limited as long as it has a characteristic of being dissolved in an alkaline developer upon contact with the alkaline developer, and is preferably a resin having an acidic functional group such as a sulfonic acid group, a phosphoric acid group, a sulfonamide group, or an active imide group in at least one of a main chain or a side chain in a polymer, examples of which include a resin containing 10% by mole or more of such a monomer having an acidic functional group that imparts alkali solubility, with a resin containing 20% by mole or more of such a monomer having an acidic functional group that imparts alkali solubility being more preferred. In a case where the copolymerization component of the monomer that imparts alkali solubility is 10% by mole or more, alkali solubility is sufficiently obtained and developability is excellent.

The alkali-soluble resin preferably has a weight-average molecular weight of 2,000 or more and a number-average molecular weight of 500 or more and more preferably has a weight-average molecular weight of more than 5,000 and 300,000 or less and a number-average molecular weight of 800 to 250,000. In addition, the dispersity (weight-average molecular weight/number-average molecular weight) of the other alkali-soluble resins is preferably 1.1 to 10.

### Content

The alkali-soluble resin in the positive-working photosensitive resin composition according to the present disclosure may be used alone or in combination of two or more thereof.

In addition, the content of the alkali-soluble resin in the present disclosure is preferably 10% by mass to 90% by mass, more preferably 20% by mass to 80% by mass, and still more preferably 30% by mass to 80% by mass with respect to the total solid content of the positive-working photosensitive resin composition.

### Infrared Absorber

The positive-working photosensitive resin composition contains an infrared absorber.

The infrared absorber is not particularly limited as long as it is a dye that absorbs infrared light to generate heat, and various dyes known as the infrared absorber can be used.

Examples of the infrared absorber that can be used in the present disclosure include the infrared absorbers described in paragraphs to of WO2016/047392A.

Of these dyes, particularly preferred are a cyanine dye, a phthalocyanine dye, an oxonol dye, a squarylium coloring agent, a pyrylium salt, a thiopyrylium dye, and a nickel thiolate complex. Furthermore, a cyanine dye represented by Formula (a) is most preferred because it is favorable in releasing the dissolution suppression action due to exposure and is also excellent in stability and economy in a case of being used in the upper layer of the positive-working lithographic printing plate precursor according to the present disclosure.

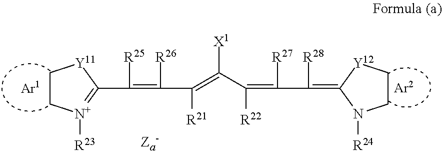

In Formula (a), X¹ represents a hydrogen atom, a halogen atom, a diarylamino group, —X²—L¹, or a group represented by Formula (b). X² represents an oxygen atom or a sulfur atom, and L¹ represents a hydrocarbon group having 1 to 12 carbon atoms, an aromatic ring having a heteroatom, or a hydrocarbon group having 1 to 12 carbon atoms and containing a heteroatom. Here, the heteroatom represents N, S, O, a halogen atom, or Se.

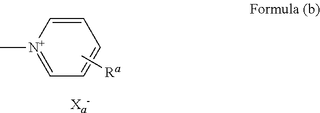

In Formula (b), Xa⁻ is defined in the same manner as Za⁻ which will be described later, and R^{a} represents a substituent selected from the group consisting of a hydrogen atom, an alkyl group, an aryl group, a substituted or unsubstituted amino group, and a halogen atom.

R²¹ and R²² each independently represent a hydrocarbon group having 1 to 12 carbon atoms. From the viewpoint of storage stability of the positive-working lithographic printing plate precursor, it is preferable that R²¹ and R²² are each a hydrocarbon group having 2 or more carbon atoms, and further, it is particularly preferable that R²¹ and R²² are bonded to each other to form a 5-membered ring or a 6-membered ring.

Ar¹ and Ar² may be the same as or different from each other and each represent an aromatic hydrocarbon group which may have a substituent. Preferred examples of the aromatic hydrocarbon group include a benzene ring and a naphthalene ring. In addition, preferred examples of the substituent include a hydrocarbon group having 1 to 12 carbon atoms, a halogen atom, and an alkoxy group having 1 to 12 carbon atoms.

Y¹¹ and Y¹² may be the same as or different from each other and each represent a sulfur atom or a dialkylmethylene group having 3 to 12 carbon atoms. R²³ and R²⁴ may be the same as or different from each other and each represent a hydrocarbon group having 1 to 20 carbon atoms which may have a substituent. Preferred examples of the substituent include an alkoxy group having 1 to 12 carbon atoms, a carboxyl group, and a sulfo group.

R²⁵, R²⁶, R²⁷, and R²⁸ may be the same as or different from each other and each represent a hydrogen atom or a hydrocarbon group having 1 to 12 carbon atoms. A hydrogen atom is preferable from the viewpoint of availability of raw materials. In addition, Za⁻ represents a counter anion. In this regard, Za⁻ is not necessary in a case where the cyanine dye represented by Formula (a) has an anionic substituent in the structure thereof and charge neutralization is not required. From the viewpoint of storage stability of the positive-working lithographic printing plate precursor, Za⁻ is preferably a halide ion, a perchlorate ion, a tetrafluoroborate ion, a hexafluorophosphate ion, or an aryl sulfonate ion, and particularly preferably a perchlorate ion, a hexafluorophosphate ion, or an aryl sulfonate ion.

Specific examples of the cyanine dye represented by Formula (a) that can be suitably used include those described in paragraphs [0017] to [0019] of JP2001-133969A, paragraphs [0012] to [0038] of JP2002-40638A, and paragraphs [0012] to [0023] of JP2002-23360A. The infrared absorber is particularly preferably a cyanine dye A shown below.

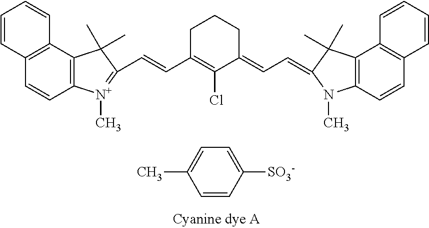

The content of the infrared absorber in the positive-working photosensitive resin composition is preferably 0.01% by mass to 50% by mass, more preferably 0.1% by mass to 30% by mass, and particularly preferably 1.0% by mass to 30% by mass with respect to the total solid content of the positive-working photosensitive resin composition. In a case where the content of the infrared absorber is 0.01% by mass or more, the sensitivity is high, and in a case where the content of the infrared absorber is 50% by mass or less, the uniformity of a layer to be obtained is good and the durability of the layer is excellent.

### Acid Generator

From the viewpoint of improving sensitivity to exposure, the positive-working photosensitive resin composition preferably contains an acid generator.

In the present disclosure, the acid generator is a compound that generates an acid by light or heat and refers to a compound that decomposes by irradiation with infrared rays or heating to 100° C. or higher to generate an acid. The acid to be generated is preferably a strong acid having a pKa of 2 or less such as sulfonic acid or hydrochloric acid. The acid generated from this acid generator results in increased permeability of the developer to an exposed portion and further improved solubility of the exposed portion in an alkali aqueous solution.

Examples of the acid generator that can be suitably used in the positive-working photosensitive resin composition according to the present disclosure include the acid generators described in paragraphs to of WO2016/047392A.

Above all, from the viewpoint of sensitivity and stability, it is preferable to use an onium salt compound as the acid generator. Hereinafter, the onium salt compound will be described.

Examples of the onium salt compound that can be suitably used in the positive-working photosensitive resin composition according to the present disclosure include compounds which are known as compounds that decompose due to heat energy generated from an infrared absorber upon exposure to infrared rays and exposure to light to generate an acid. From the viewpoint of sensitivity, examples of the onium salt compound suitable for the positive-working photosensitive resin composition according to the present disclosure include known thermal polymerization initiators and compounds having an onium salt structure shown below, which have a bond with a small bond dissociation energy.

Examples of the onium salt that is suitably used in the positive-working photosensitive resin composition according to the present disclosure include a diazonium salt, an iodonium salt, a sulfonium salt, an ammonium salt, a pyridinium salt, and an azinium salt, each of which is known, among which triarylsulfonium or diaryliodonium sulfonate or carboxylate, BF₄⁻, PF₆⁻, ClO₄⁻, and the like are preferred.

Examples of the onium salt that is used as the acid generator in the positive-working photosensitive resin composition according to the present disclosure include onium salts represented by Formulae (III) to (V).

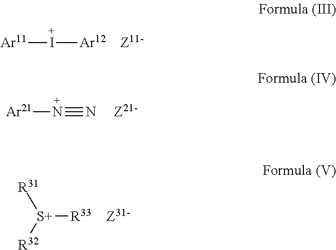

In Formula (III), Ar¹¹ and Ar¹² each independently represent an aryl group having 6 to 20 carbon atoms which may have a substituent. In a case where the aryl group has a substituent, preferred examples of the substituent include a halogen atom, a nitro group, an alkyl group having 1 to 12 carbon atoms, an alkoxy group having 1 to 12 carbon atoms, and an aryloxy group having 1 to 12 carbon atoms. Z¹¹⁻ represents a counterion selected from the group consisting of a halide ion, a perchlorate ion, a tetrafluoroborate ion, a hexafluorophosphate ion, an aryl sulfonate ion, and a sulfonate ion having a fluorine atom, such as a perfluoroalkyl sulfonate ion, and is preferably a perchlorate ion, a hexafluorophosphate ion, an aryl sulfonate ion, or a perfluoroalkyl sulfonate ion.

In Formula (IV), Ar²¹ represents an aryl group having 6 to 20 carbon atoms which may have a substituent. Preferred examples of the substituent include a halogen atom, a nitro group, an alkyl group having 1 to 12 carbon atoms, an alkoxy group having 1 to 12 carbon atoms, an aryloxy group having 1 to 12 carbon atoms, an alkylamino group having 1 to 12 carbon atoms, a dialkylamino group having 2 to 12 carbon atoms, an arylamino group having 6 to 12 carbon atoms, and a diarylamino group (each independently has 6 to 12 carbon atoms in the aryl group). Z²¹⁻ represents a counterion having the same meaning as Z¹¹⁻.

In Formula (V), R³¹, R³², and R³³ may be the same as or different from each other and each represent a hydrocarbon group having 1 to 20 carbon atoms which may have a substituent. Preferred examples of the substituent include a halogen atom, a nitro group, an alkyl group having 1 to 12 carbon atoms, an alkoxy group having 1 to 12 carbon atoms, and an aryloxy group having 1 to 12 carbon atoms. Z³¹⁻ represents a counterion having the same meaning as Z¹¹⁻.

Specific examples of the onium salt that can be suitably used in the positive-working photosensitive resin composition according to the present disclosure are the same as the compounds described in paragraphs to of WO2016/047392A.

In addition, other examples of the compounds represented by Formulae (III) to (V), the compounds described as examples of the radical polymerization initiator in paragraphs to of JP2008-195018A can be suitably used as the acid generator in the positive-working photosensitive resin composition according to the present disclosure.

More preferred examples of the acid generator that can be used in the positive-working photosensitive resin composition according to the present disclosure include compounds represented by Formula PAG-1 to Formula PAG-5. In Formula PAG-1 to Formula PAG-5, Me represents a methyl group.

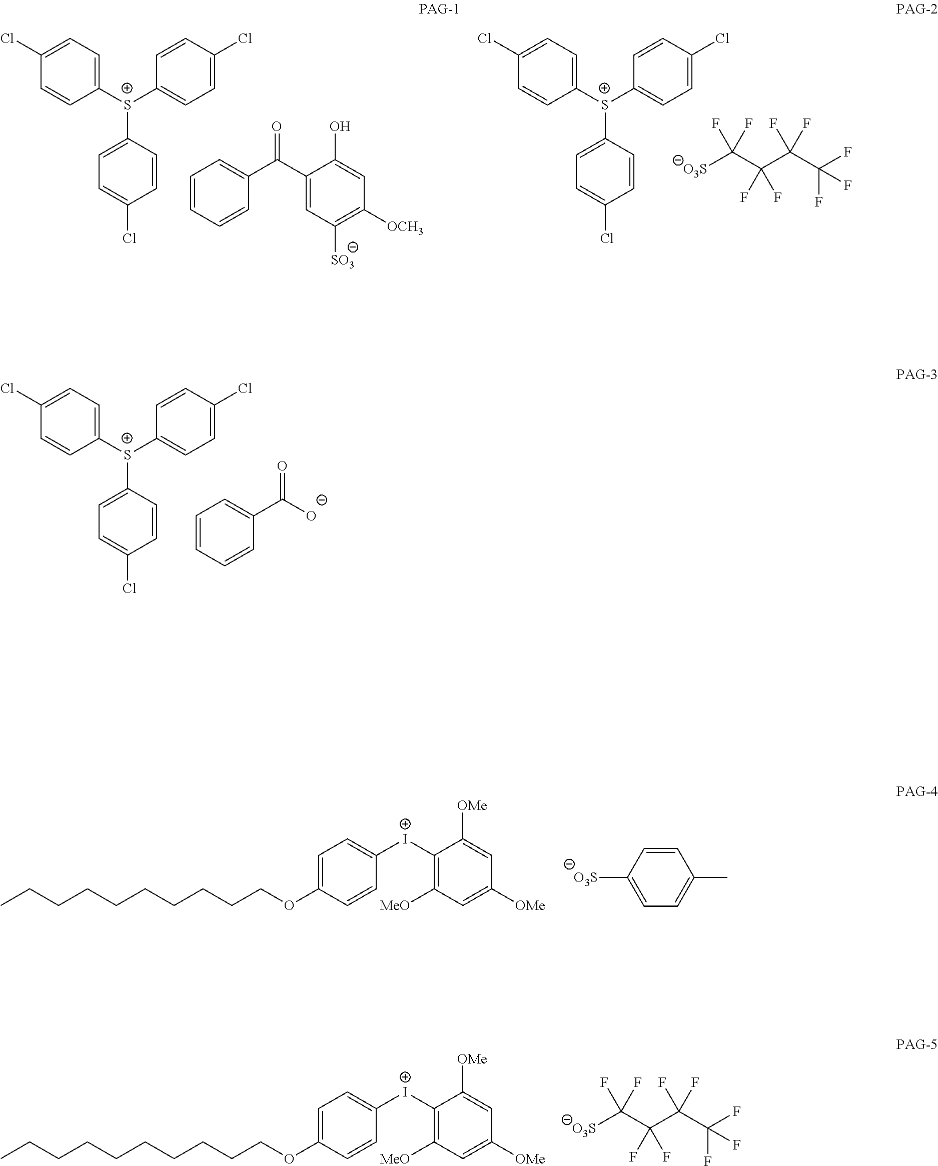

In a case where these acid generators are contained in the positive-working photosensitive resin composition according to the present disclosure, these compounds may be used alone or in combination of two or more thereof.

The content of the acid generator is in a range of 0.01% by mass to 50% by mass, preferably 0.1% by mass to 40% by mass, and more preferably 0.5% by mass to 30% by mass with respect to the total solid content of the positive-working photosensitive resin composition. In a case where the content of the acid generator is in the above-mentioned range, an improvement in sensitivity, which is the effect of adding the acid generator, is observed, and the generation of a residual film in a non-image area is suppressed.

### Acid Proliferation Agent

The positive-working photosensitive resin composition may contain an acid proliferation agent. The acid proliferation agent in the present disclosure is a compound substituted with a residue of a relatively strong acid, which is a compound that is easily eliminated in the presence of an acid catalyst to newly generate an acid. That is, the acid proliferation agent is decomposed by an acid-catalyzed reaction to generate an acid again. One or more acids increase in one reaction, and the acid concentration increases at an accelerated rate with the progress of the reaction, resulting in a dramatic improvement in sensitivity. The strength of the generated acid is preferably 3 or less and more preferably 2 or less in terms of an acid dissociation constant (pKa). In a case where the acid dissociation constant is 3 or less, an elimination reaction by an acid catalyst is likely to occur.

Examples of the acid used in such an acid catalyst include dichloroacetic acid, trichloroacetic acid, methanesulfonic acid, ethanesulfonic acid, benzenesulfonic acid, p-toluenesulfonic acid, naphthalenesulfonic acid, and phenylsulfonic acid.

The usable acid proliferation agents are the same as those described in paragraphs to of WO2016/047392A.

The content of these acid proliferation agents is in a range of 0.01% by mass to 20% by mass, preferably 0.01% by mass to 10% by mass, and more preferably 0.1% by mass to 5% by mass with respect to the total mass of the positive-working photosensitive resin composition. In a case where the content of the acid proliferation agent is in the above-mentioned range, the effect of adding the acid proliferation agent is sufficiently obtained, the sensitivity to exposure is improved, and the decrease in the film hardness of the image area is suppressed.

### Other Additives

The positive-working photosensitive resin composition may contain a development accelerator, a surfactant, a bake-out agent/colorant, a plasticizer, a wax agent, and the like as other additives. For these additives, the same compounds as those described in paragraphs to of WO2016/047392A can be used.

### Compositional Ratio of Each Component

The content of the specific compound is preferably 0.05% by mass to 30% by mass, the content of the alkali-soluble resin is preferably 10% by mass to 90% by mass, the content of the infrared absorber is preferably 0.01% to 50% by mass, the content of the acid generator is preferably 0% to 50% by mass, the content of the acid proliferation agent is preferably 0% to 20% by mass, the content of the development accelerator is preferably 0% to 20% by mass, the content of the surfactant is preferably 0% to 5% by mass, the content of the bake-out agent/colorant is preferably 0% to 10% by mass, the content of the plasticizer is preferably 0% to 10% by mass, and the content of the wax agent is preferably 0% to 10% by mass, with respect to the total solid content of the positive-working photosensitive resin composition according to the present disclosure.

The positive-working photosensitive resin composition according to the present disclosure is capable of recording with high sensitivity, has excellent image formability, and exhibits good durability of a formed image area, so the positive-working lithographic printing plate precursor according to the present disclosure, which has an image-recording layer consisting of the positive-working photosensitive resin composition, makes it possible to prepare a lithographic printing plate having excellent printing durability.

### Configuration of Positive-Working Lithographic Printing Plate Precursor

The positive-working lithographic printing plate precursor according to the present disclosure has an image-recording layer containing the above-mentioned positive-working photosensitive resin composition on a support having a hydrophilic surface.

The image-recording layer may be of a single layer or may be an image-recording layer having a multi-layer structure with a lower layer and an upper layer in the vicinity of the support.

Further, it is preferable that the image-recording layer is an image-recording layer having a lower layer and an upper layer in this order from the support side, and at least one of the lower layer or the upper layer consists of the positive-working photosensitive resin composition, and it is more preferable that each of the lower layer and the upper layer consists of the positive-working photosensitive resin composition.

The image-recording layer in the positive-working lithographic printing plate precursor according to the present disclosure can be formed by dissolving each component of the above-mentioned positive-working photosensitive resin composition in a solvent, applying the solution onto an appropriate support, and curing the applied solution.

Examples of the solvent to be used herein include, but are not limited to, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene. These solvents may be used alone or in combination.

### Formation of Lower Layer and Upper Layer

In addition, the positive-working lithographic printing plate precursor according to the present disclosure is preferably a positive-working lithographic printing plate precursor having an image-recording layer having a lower layer and an upper layer in this order on a support (hereinafter, also referred to as “an image-recording layer having a two-layer structure”).

In principle, it is preferable that the lower layer and the upper layer are formed as two separate layers.

Examples of the method for forming the two layers separately include a method that utilizes a difference in solubility in a solvent between the components contained in the lower layer and the components contained in the upper layer, and a method in which the upper layer is applied and then the solvent is quickly dried and removed. The latter method is preferably used in combination since the separation between the layers is further improved.

Hereinafter, these methods will be described in more detail, but the method for applying the two layers separately is not limited thereto.

The method that utilizes a difference in solubility in a solvent between the components contained in the lower layer and the components contained in the upper layer is to use a solvent system in which none of the components contained in the lower layer are soluble in a case where a coating liquid for an upper layer is applied. This makes it possible to form a coating film with each layer clearly separated even in a case where two-layer application is carried out. For example, a component insoluble in a solvent such as methyl ethyl ketone or 1-methoxy-2-propanol, which dissolves an alkali-soluble resin that is the upper layer component, is selected as the lower layer component, the lower layer is applied using a solvent system that dissolves the lower layer component and dried, and then the upper layer mainly composed of the alkali-soluble resin is dissolved in methyl ethyl ketone, 1-methoxy-2-propanol, or the like, applied, and dried, thereby making it possible to form a two-layer structure.

Next, a method for extremely quickly drying the solvent after the second layer (upper layer) is applied can be achieved by blowing high-pressure air from a slit nozzle installed almost perpendicular to the running direction of the web, by applying thermal energy as conductive heat from the lower surface of the web from a roll (heating roll) into which a heating medium such as steam is supplied, or by a combination of these methods.

The specific compound is preferably contained in at least one of the lower layer or the upper layer, more preferably contained only in the upper layer, and particularly preferably contained only in the lower layer or contained in both the upper layer and the lower layer.

The applied amount after drying of the lower layer component applied onto the support of the positive-working lithographic printing plate precursor according to the present disclosure is preferably in a range of 0.5 g/m² to 4.0 g/m² and more preferably in a range of 0.6 g/m² to 2.5 g/m². In a case where the applied amount after drying of the lower layer component is 0.5 g/m² or more, the printing durability is excellent, and in a case where the applied amount after drying of the lower layer component is 4.0 g/m² or less, the image reproducibility and the sensitivity are excellent.

In addition, the applied amount after drying of the upper layer component is preferably in a range of 0.05 g/m² to 1.0 g/m² and more preferably in a range of 0.08 g/m² to 0.7 g/m². In a case where the applied amount after drying of the upper layer component is 0.05 g/m² or more, the development latitude and the scratch resistance are excellent, and in a case where the applied amount after drying of the upper layer component is 1.0 g/m² or less, the sensitivity is excellent.

The total applied amount after drying of the lower layer and the upper layer is preferably in a range of 0.6 g/m² to 4.0 g/m² and more preferably in a range of 0.7 g/m² to 2.5 g/m². In a case where the total applied amount after drying of the lower layer and the upper layer is 0.6 g/m² or more, the printing durability is excellent, and in a case where the total applied amount after drying of the lower layer and the upper layer is 4.0 g/m² or less, the image reproducibility and the sensitivity are excellent.

### Upper Layer

The upper layer of the image-recording layer having a two-layer structure in the present disclosure may be a layer consisting of the positive-working photosensitive resin composition according to the present disclosure, and is preferably a layer consisting of a resin composition other than the positive-working photosensitive resin composition according to the present disclosure.

The upper layer of the image-recording layer having a two-layer structure in the present disclosure is preferably an infrared-sensitive positive-working image-recording layer whose solubility in an alkali aqueous solution is improved by heat.

The mechanism by which the solubility in an alkali aqueous solution is improved by heat in the upper layer is not particularly limited, and any of those which contain a binder resin and in which the solubility of the heated region is improved can be used. Examples of the heat used for the formation of an image include heat generated in a case where a lower layer containing an infrared absorber is exposed.

Preferred examples of the upper layer whose solubility in an alkali aqueous solution is improved by heat include a layer containing an alkali-soluble resin having hydrogen-bonding properties, such as novolac or urethane, a layer containing a water-insoluble, alkali-soluble resin and a compound having a dissolution suppressing action, and a layer containing an ablatable compound.

More specifically, it is preferable that the upper layer contains an infrared absorber and a water-insoluble, alkali-soluble resin, the water-insoluble, alkali-soluble resin being at least one selected from the group consisting of a polyamide resin, an epoxy resin, a polyacetal resin, an acrylic resin, a methacrylic resin, a polystyrene-based resin, and a novolac-type phenolic resin, and an interaction is formed between a polar group contained in the water-insoluble, alkali-soluble resin and the infrared absorber.

In the upper layer, the formation of the above-mentioned interaction makes it possible to suppress the occurrence of undesired ablation on the surface of the upper layer due to exposure without deteriorating the developability of an exposed portion.

In addition, by further adding an infrared absorber to the upper layer, the heat generated in the upper layer can also be used for the formation of an image. Preferred examples of the configuration of the upper layer containing an infrared absorber include a layer containing an infrared absorber, a water-insoluble, alkali-soluble resin, and a compound having a dissolution suppressing action, and a layer containing an infrared absorber, a water-insoluble, alkali-soluble resin, and an acid generator.

### Water-Insoluble, Alkali-Soluble Resin

It is preferable that the upper layer of the image-recording layer having a two-layer structure in the present disclosure contains a water-insoluble, alkali-soluble resin. By containing the water-insoluble, alkali-soluble resin, an interaction is formed between the infrared absorber and the polar group contained in the water-insoluble, alkali-soluble resin, and a layer having positive-working photosensitivity is formed.

Common water-insoluble, alkali-soluble resins will be described in more detail below, and above all, preferred examples thereof include a polyamide resin, an epoxy resin, a polyacetal resin, an acrylic resin, a methacrylic resin, a polystyrene-based resin, and a novolac-type phenolic resin.

The water-insoluble, alkali-soluble resin is not particularly limited as long as it has a characteristic of being dissolved in an alkaline developer upon contact with the alkaline developer, and is preferably a homopolymer containing an acidic group in at least one of a main chain or a side chain in a polymer, a copolymer thereof, or a mixture thereof.

Such a water-insoluble, alkali-soluble resin having an acidic group preferably has a functional group such as a phenolic hydroxyl group, a carboxy group, a sulfonic acid group, a phosphoric acid group, a sulfonamide group, or an active imide group. Therefore, such a resin can be suitably produced by copolymerizing a monomer mixture containing one or more ethylenically unsaturated monomers having the above-mentioned functional group. Preferred examples of the ethylenically unsaturated monomer having the above-mentioned functional group include acrylic acid, methacrylic acid, and also compounds represented by the following formulae and a mixture thereof. In the formulae, R⁴⁰ represents a hydrogen atom or a methyl group.

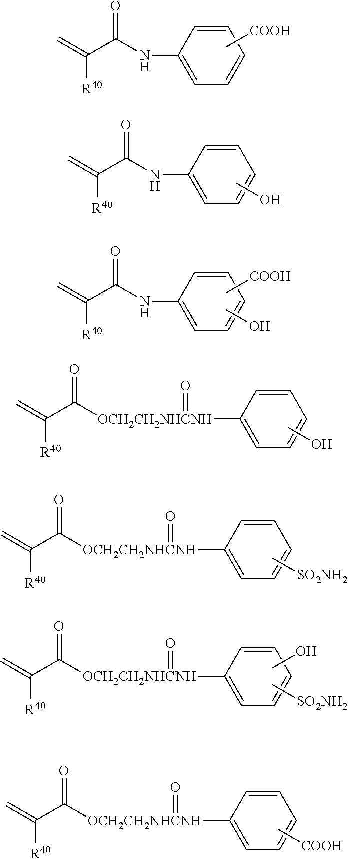

The water-insoluble, alkali-soluble resin is preferably a polymer compound obtained by copolymerizing the above-mentioned polymerizable monomers with other polymerizable monomers. In this case, the copolymerization ratio is preferably such that the content of a monomer that imparts alkali solubility, such as a monomer having a functional group such as a phenolic hydroxyl group, a carboxy group, a sulfonic acid group, a phosphoric acid group, a sulfonamide group, or an active imide group, is 10% by mole or more, and more preferably such that the content of the monomer is 20% by mole or more. In a case where the copolymerization component of the monomer that imparts alkali solubility is 10% by mole or more, alkali solubility is sufficiently obtained, and developability is excellent.

Examples of other polymerizable monomers that can be used include the compounds listed below.

Alkyl acrylates and alkyl methacrylates such as methyl acrylate, ethyl acrylate, propyl acrylate, benzyl acrylate, methyl methacrylate, ethyl methacrylate, cyclohexyl methacrylate, and benzyl methacrylate. Acrylic acid esters and methacrylic acid esters having an aliphatic hydroxyl group, such as 2-hydroxyethyl acrylate and 2-hydroxyethyl methacrylate. Acrylamides and methacrylamides such as acrylamide, methacrylamide, N-methylacrylamide, N-ethylacrylamide, and N-phenylacrylamide. Vinyl esters such as vinyl acetate, vinyl chloroacetate, vinyl butyrate, and vinyl benzoate. Styrenes such as styrene, α-methylstyrene, methylstyrene, and chloromethylstyrene. Other nitrogen atom-containing monomers such as N-vinylpyrrolidone, N-vinylpyridine, acrylonitrile, and methacrylonitrile. Maleimides such as N-methylmaleimide, N-ethylmaleimide, N-propylmaleimide, N-butylmaleimide, N-phenylmalcimide, N-2-methylphenylmalcimide, N-2,6-diethylphenylmaleimide, N-2-chlorophenylmaleimide, N-cyclohexylmalcimide, N-laurylmaleimide, and N-hydroxyphenylmalcimide.

Among these other ethylenically unsaturated monomers, (meth)acrylic acid esters, (meth)acrylamides, maleimides, and (meth)acrylonitriles are suitably used.

In addition, preferred examples of the alkali-soluble resin also include the novolac resins mentioned as other alkali-soluble resins mentioned as the optional components of the positive-working photosensitive resin composition according to the present disclosure.

In addition, the above-mentioned water-insoluble, alkali-soluble resin can also be used in the positive-working photosensitive resin composition according to the present disclosure.

Furthermore, in the upper layer of the image-recording layer having a two-layer structure in the present disclosure, other resins can be used in combination within a range that does not impair the effects of the positive-working lithographic printing plate precursor according to the present disclosure. The upper layer itself is required to exhibit alkali solubility, particularly in the non-image area, and therefore it is necessary to select a resin that does not impair this property. From this viewpoint, examples of the resin that can be used in combination include a water-insoluble, alkali-soluble resin. Common water-insoluble, alkali-soluble resins will be described in more detail below, and above all, preferred examples thereof include a polyamide resin, an epoxy resin, a polyacetal resin, an acrylic resin, a methacrylic resin, a polystyrene-based resin, and a novolac-type phenolic resin.

In addition, the amount of the resin to be mixed is preferably 50% by mass or less with respect to the water-insoluble, alkali-soluble resin.

The water-insoluble, alkali-soluble resin preferably has a weight-average molecular weight of 2,000 or more and a number-average molecular weight of 500 or more, and more preferably has a weight-average molecular weight of 5,000 to 300,000 and a number-average molecular weight of 800 to 250,000. In addition, the dispersity (weight-average molecular weight/number-average molecular weight) of the water-insoluble, alkali-soluble resin is preferably 1.1 to 10.

The water-insoluble, alkali-soluble resins may be used alone or in combination of two or more thereof.

The content of the water-insoluble, alkali-soluble resin is preferably 2.0% by mass to 99.5% by mass, more preferably 10.0% by mass to 99.0% by mass, and still more preferably 20.0% by mass to 90.0% by mass with respect to the total solid content mass of the upper layer of the image-recording layer having a two-layer structure in the present disclosure. In a case where the content of the water-insoluble, alkali-soluble resin is 2.0% by mass or more, the durability of the image-recording layer (photosensitive layer) is excellent, and in a case where the content of the water-insoluble, alkali-soluble resin is 99.5% by mass or less, both the sensitivity and the durability are excellent.

### Infrared Absorber

The upper layer may contain an infrared absorber.

The infrared absorber is not particularly limited as long as it is a dye that absorbs infrared light and generates heat, and the infrared absorber used in the positive-working photosensitive resin composition according to the present disclosure described above can be used in the same manner.

### The Particularly Preferred Dye is the Cyanine Dye Represented by Formula (a).

In a case where the infrared absorber is contained in the upper layer, a positive-working lithographic printing plate precursor having excellent image formability can be obtained.

The content of the infrared absorber in the upper layer is preferably 0.01% by mass to 50% by mass, more preferably 0.1% by mass to 30% by mass, and particularly preferably 1.0% by mass to 10% by mass with respect to the total solid content of the upper layer. In a case where the content of the infrared absorber is 0.01% by mass or more, the sensitivity is improved, and in a case where the content of the infrared absorber is 50% by mass or less, the uniformity of the layer is good and the durability of the layer is excellent.

### Surfactant

From the viewpoint of improving the surface state of the coating film, the above-mentioned upper layer preferably contains a surfactant.

Examples of the surfactant include a nonionic surfactant, an anionic surfactant, a cationic surfactant, an amphoteric surfactant, and a fluorine-based surfactant. The surfactants may be used alone or in combination of two or more thereof.

The nonionic surfactant used in the present disclosure is not particularly limited, and any known nonionic surfactant in the related art can be used. Examples of the nonionic surfactant include polyoxyethylene alkyl ethers, polyoxyethylene alkylphenyl ethers, polyoxyethylene-polystyryl phenyl ethers, polyoxyethylene-polyoxypropylene alkyl ethers, partial fatty acid esters of glycerol, partial fatty acid esters of sorbitan, partial fatty acid esters of pentaerythritol, monoesters of fatty acids with propylene glycol, partial fatty acid esters of sucrose, partial fatty acid esters of polyoxyethylene sorbitan, partial fatty acid esters of polyoxyethylene-sorbitol, polyethylene glycol fatty acid esters, partial fatty acid esters of polyglycerol, polyoxyethylated castor oils, partial fatty acid esters of polyoxyethylene glycerol, fatty acid diethanolamides, N,N-bis-2-hydroxyalkylamines, polyoxyethylene alkylamines, triethanolamine fatty acid esters, trialkylamine oxides, polyethylene glycol, and copolymers of polyethylene glycol and polypropylene glycol.

The anionic surfactant used in the present disclosure is not particularly limited, and any known anionic surfactant in the related art can be used. Examples of the anionic surfactant include fatty acid salts, abietic acid salts, hydroxyalkanesulfonates, alkanesulfonates, dialkylsulfosuccinates, linear alkylbenzenesulfonates, branched alkylbenzenesulfonates, alkylnaphthalenesulfonates, alkylphenoxypolyoxyethylene propylsulfonates, polyoxyethylene alkylsulfophenyl ether salts, N-methyl-N-oleyltaurine sodium salts, N-alkylsulfosuccinic acid monoamide disodium salts, petroleum sulfonates, sulfonated tallow oils, sulfuric acid ester salts of fatty acid alkyl esters, alkylsulfuric acid ester salts, polyoxyethylene alkyl ether sulfuric acid ester salts, fatty acid monoglyceride sulfuric acid ester salts, polyoxyethylene alkylphenyl ether sulfuric acid ester salts, polyoxyethylene styrylphenyl ether sulfuric acid ester salts, alkyl phosphate salts, polyoxyethylene alkyl ether phosphate salts, polyoxyethylene alkylphenyl ether phosphate salts, partially saponified products of a styrene/maleic anhydride copolymer, partially saponified products of an olefin/maleic anhydride copolymer, and naphthalene sulfonate/formalin condensates.

The cationic surfactant used in the present disclosure is not particularly limited, and any known cationic surfactant in the related art can be used. Examples of the cationic surfactant include alkylamine salts, quaternary ammonium salts, polyoxyethylene alkylamine salts, and polyethylene polyamine derivatives.

The amphoteric surfactant used in the present disclosure is not particularly limited, and any known amphoteric surfactant in the related art can be used. Examples of the amphoteric surfactant include carboxybetaines, aminocarboxylic acids, sulfobetaines, aminosulfuric acid esters, and imidazolines.

Among the above-mentioned surfactants, those described as “polyoxyethylene” can also be read as “polyoxyalkylene” such as polyoxymethylene, polyoxypropylene, or polyoxybutylene, and those surfactants can also be used in the present disclosure.

Further preferred examples of the surfactant include a fluorine-based surfactant containing a perfluoroalkyl group in a molecule. Examples of such a fluorine-based surfactant include anionic types such as perfluoroalkyl carboxylates, perfluoroalkyl sulfonates, and perfluoroalkyl phosphates; amphoteric types such as perfluoroalkyl betaines; cationic types such as perfluoroalkyl trimethylammonium salts; and nonionic types such as perfluoroalkyl amine oxides, perfluoroalkyl ethylene oxide adducts, oligomers containing a perfluoroalkyl group and a hydrophilic group, oligomers containing a perfluoroalkyl group and a lipophilic group, oligomers containing a perfluoroalkyl group, a hydrophilic group, and a lipophilic group, and urethanes containing a perfluoroalkyl group and a lipophilic group. In addition, suitable examples thereof also include the fluorine-based surfactants described in JP1987-170950A (JP-S62-170950A), JP1987-226143A (JP-S62-226143A), and JP1985-168144A (JP-S60-168144A).

In addition to the above-mentioned surfactants, other surfactants can be added, such as amphoteric surfactants as described in JP1984-121044A (JP-S59-121044A) and JP1992-013149A (JP-H04-013149A); siloxane-based compounds as described in EP950517A; fluorine-containing monomer copolymers as described in JP1999-288093A (JP-H11-288093A); and fluorine-based surfactants as described in JP1987-170950A (JP-S62-170950A), in order to broaden the stability of the treatment for the development conditions of the present disclosure or to improve the coating properties, within a range that does not impair the effects of the present disclosure.

Specific examples of the amphoteric surfactant include alkyl di(aminoethyl) glycine, alkyl polyaminocthyl glycine hydrochloride, 2-alkyl-N-carboxyethyl-N-hydroxyethylimidazolinium betaine, and N-tetradecyl-N,N-betaine type amphoteric surfactant (for example, trade name “AMOGEN K”, manufactured by DKS Co., Ltd.). A block copolymer of dimethylsiloxane and polyalkylene oxide is preferable as the siloxane-based compound, and specific examples thereof include polyalkylene oxide-modified silicones such as DBE-224, DBE-621, DBE-712, DBP-732, and DBP-534 manufactured by Chisso Corporation, and Tego Glide 100 manufactured by Tego GmbH (Germany).

Specific examples of commercially available surfactants include the following.

“DOWSIL”, “XIAMETER”, and “SYLGARD” are registered trademarks. In the following, the description that “DOWSIL”, “XIAMETER”, and “SYLGARD” are registered trademarks will be omitted.

Examples of products manufactured by Dow Toray Co., Ltd. include DOWSIL BY 16-205, DOWSIL BY 16-849 Fluid, DOWSIL FZ-3710 Fluid, DOWSIL FZ-3760, DOWSIL FZ-3785, DOWSIL SF 8417 Fluid, DOWSIL BY 16-891, DOWSIL FZ-3789, DOWSIL BY 16-839 Fluid, DOWSIL SF 8411 Fluid, DOWSIL SF 8413 Fluid, DOWSIL SF 8421 Fluid, DOWSIL BY 16-880 Fluid, DOWSIL BY 16-201, DOWSIL SF 8427 Fluid, DOWSIL SF 8428 Fluid, DOWSIL 580 WAX, DOWSIL BY 16-606, DOWSIL BY 16-846 Fluid, XIAMETER OFX-0203 Fluid, XIAMETER OFX-0230 Fluid, DOWSIL SF 8416 Fluid, DOWSIL SF 8419 Fluid, DOWSIL 501 W Additive, DOWSIL FZ-2110, DOWSIL FZ-2123, DOWSIL L-7001, SYLGARD OFX-0309 Fluid, XIAMETER OFX-5211 Fluid, DOWSIL SF 8410 Fluid, DOWSIL SH 3746 Fluid, DOWSIL SH 8400 Fluid, DOWSIL SH 8700 Fluid, DOWSIL SH 510 Fluid (100 cSt, 500 cSt), DOWSIL SH 550 Fluid, DOWSIL SH 710 Fluid, and DOWSIL FS 1265 Fluid.

Examples of Shin-Etsu Silicone (registered trademark) products of Shin-Etsu Chemical Co., Ltd. include KP series such as KP-124, KP-109, KP-110, KP-121, KP-118, KP-341, KP-112, KP-125, KP-101, KP-106, KP-120, KP-105, KP-104, KP-611, KP-626, KP-327, KP-323, KP-322, KP-625, KP-623, KP-624, KP-620, KP-651, KP-652, KP-650, KP-310, KP-306, KP-301, KP-621, KP-369, KP-368, and KP-126, and KF series and FL series such as KF-868, KF-865, KF-864, KF-859, KF-393, KF-860, KF-880, KF-8004, KF-8002, KF-8005, KF-867, KF-8021, KF-869, KF-861, KF-877, KF-101, KF-1001, KF-102, KF-1002, KF-1005, KF-2001, KF-2004, KF-99, KF-9901, PAM-E, KF-8010, KF-8012, KF-8008, KF-105, KF-6000, KF-6001, KF-6002, KF-6003, KF-6123, KF-9701, KF-2012, KF-857, KF-862, KF-858, KF-351A, KF-352A, KF-353, KF-354L, KF-355A, KF-615A, KF-945, KF-640, KF-642, KF-643, KF-644, KF-6020, KF-6204, KF-6011, KF-6012, KF-6015, KF-6017, KF-410, FL-5, FL-100-100cs, FL-100-450cs, FL-100-1,000cs, FL-100-10,000cs, KF-412, KF-413, KF-414, KF-415, KF-4003, KF-4701, KF-4917, KF-7235B, KF-3935, KF-50-100cs, KF-50-300cs, KF-50-1,000cs, KF-50-3,000cs, KF-53, KF-54, and KF-6004.

Examples of products of BYK-Chemic GmbH include BYK-300, BYK-302, BYK-306, BYK-307, BYK-310, BYK-313, BYK-315 N, BYK-320, BYK-322, BYK-323, BYK-325 N, BYK-326*, BYK-327*, BYK-330, BYK-331, BYK-333, BYK-342, BYK-345/346, BYK-347, BYK-348, BYK-349, BYK-370, BYK-375, BYK-377, BYK-378, BYK-3450*, BYK-3451*, BYK-3455, BYK-3456*, BYK-3760*, BYK-UV 3500, BYK-UV 3505*, BYK-UV 3510, BYK-UV 3530, BYK-UV 3535*, BYK-UV 3570, BYK-UV 3575*, BYK-UV 3576, BYK-350, BYK-354, BYK-355/356 acrylic copolymer, BYK-358 N/361 N, BYK-381 acrylic copolymer, BYK-392 acrylic copolymer, BYK-394 acrylic copolymer, BYK-3441 acrylic copolymer, BYK-399, BYK-3440*, BYK-3550, BYK-3560*, BYK-3565*, BYK-3566*, BYK-SILCLEAN 3700, BYK-SILCLEAN 3701*, BYK-SILCLEAN 3720, and BYK-DYNWET 800 N.

### Other Components

In addition, the upper layer in the image-recording layer having a two-layer structure may contain an acid generator, an acid proliferation agent, a development accelerator, a bake-out agent, a colorant, a plasticizer, a wax agent, and the like.

In the image-recording layer having a two-layer structure, a development accelerator may be contained not only in the upper layer but also in the lower layer for the purpose of adjusting the dissolution rate of the image-recording layer. That is, the development accelerator may be contained in only at least one of the upper layer or the lower layer or may be contained in both the upper layer and the lower layer.

Examples of the development accelerator include acid anhydrides, phenols, and organic acids, examples of which include a sulfonium salt A (b-1), a sulfonium salt B (b-2), a phenolic compound (a-2), and a phenolic compound (c-1) in Examples which will be described later.

As these components, the respective components used in the positive-working photosensitive resin composition according to the present disclosure described above can be used in the same manner, and the same applies to the preferred aspects thereof.

The upper layer preferably further contains a polymer having a unit having a fluorinated alkyl group in a side chain.

In a case where the upper layer contains a polymer having a unit having a fluorinated alkyl group in a side chain, the surface state of the coating film in a case of applying the upper layer is good, and further, the ink receptivity of the image area in the lithographic printing plate can be improved.

Examples of the polymer having a unit having a fluorinated alkyl group in a side chain include the compounds as shown below.

The following compounds are available as commercially available products, and examples of the commercially available products include a fluorine-based surfactant (MEGAFACE (registered trademark, the same applies hereinafter) F-782F, available from DIC Corporation).

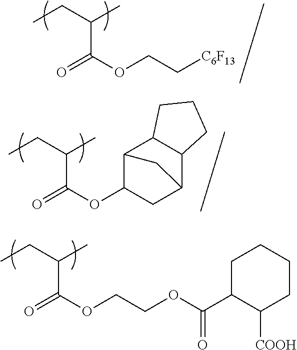

In addition, it is preferable that at least one of the upper layer or the lower layer which will be described later contains a polymer having a unit represented by Formula (I), and it is more preferable that the upper layer contains a polymer having a unit represented by Formula (I).

In addition, from the viewpoint of improving the surface state of the coating film in a case of applying the upper layer and the ink receptivity of the image area in the lithographic printing plate, a polymer having a siloxane bond in a side chain is also a preferred aspect, in addition to the polymer having a unit having a fluorinated alkyl group in a side chain. Specific examples of the structure include a polymer in which the unit having a fluorinated alkyl group in the polymer of the above-mentioned structure is changed to a unit having a three-branched siloxane structure.

Examples of the unit having a three-branched siloxane structure include the units shown below.

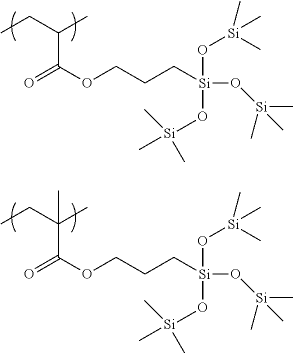

Examples of the polymer in which the unit containing a fluorinated alkyl group in the polymer having a unit containing a fluorinated alkyl group in a side chain is changed to a unit having a three-branched siloxane structure include the polymers shown below.

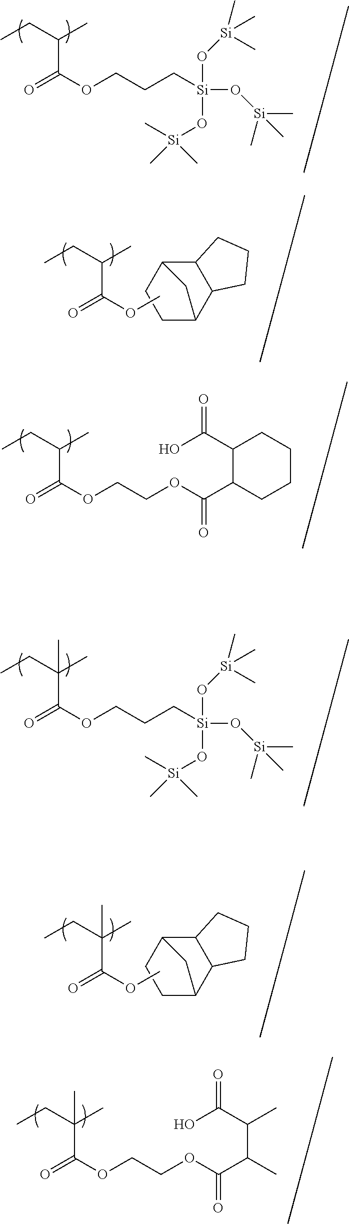

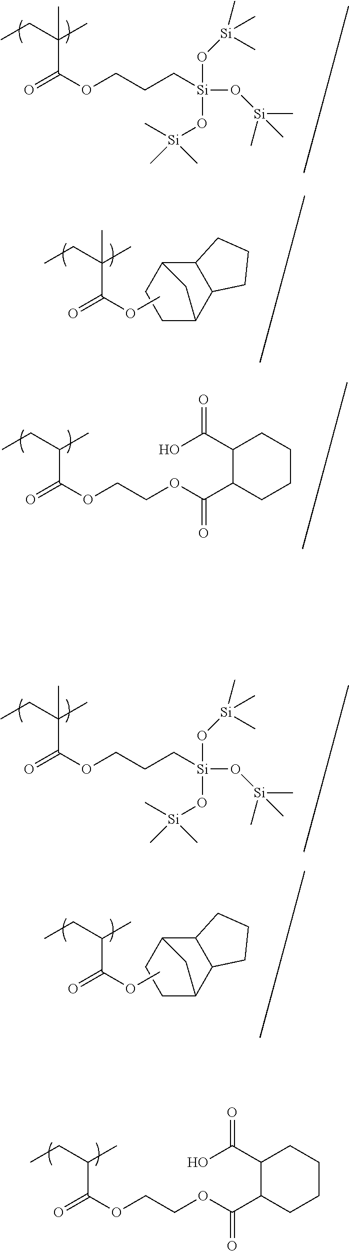

The main chain skeleton in the polymer having a unit containing a fluorinated alkyl group in a side chain and the polymer having a siloxane bond in a side chain is not particularly limited, and examples thereof include an acrylic skeleton and a methacrylic skeleton. The main chain skeletons of the respective units constituting the polymer may be the same as or different from each other.

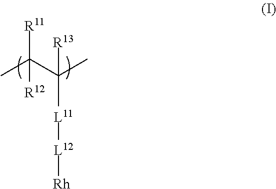

In Formula (I), R¹¹ and R¹² each independently represent a hydrogen atom or an alkyl group, R¹³ represents a hydrogen atom or a monovalent substituent, L¹¹ and L¹² each independently represent a single bond or a divalent linking group, and Rh represents a substituent containing two or more silicon atoms.

Examples of the alkyl group represented by R¹¹ and R¹² include a linear alkyl group having 1 to 18 carbon atoms, and a branched or cyclic alkyl group having 3 to 18 carbon atoms.

Specific examples of the alkyl group represented by R¹¹ and R¹² include a methyl group, an ethyl group, a propyl group, a butyl group, an isopropyl group, a tert-butyl group, and a cyclohexyl group.

It is preferable that R¹¹ and R¹² are both hydrogen atoms.

Examples of the monovalent substituent represented by R¹³ include an alkyl group, an alkenyl group, and an aryl group.

Examples of the divalent linking group represented by L¹¹ include —C(═O)—O— (a so-called ester bond) and —C(═O)—NH—.

The divalent linking group represented by L¹¹ is preferably —C(═O)—O— which is an ester bond.

The divalent linking group represented by L¹² is not particularly limited as long as it is a group capable of linking L¹¹ and Rh. Examples of the divalent linking group represented by L¹² include an alkylene group. The alkylene group is preferably an alkylene group having 2 to 10 carbon atoms and more preferably an alkylene group having 4 to 8 carbon atoms.

The substituent containing two or more silicon atoms, which is represented by Rh, is not particularly limited as long as the atomic group constituting the substituent contains two or more silicon atoms. From the viewpoint of on-press developability, it is preferable that the substituent containing two or more silicon atoms contains the silicon atom as a silicon-oxygen bond (Si—O bond). The substituent containing two or more silicon atoms preferably has two or more silicon-oxygen bonds, more preferably has three or more silicon-oxygen bonds, and still more preferably has three to twelve silicon-oxygen bonds. The substituent containing two or more silicon atoms preferably contains a silicon-oxygen bond as a polysiloxane structure.

In addition, from the viewpoint of on-press developability, the substituent containing two or more silicon atoms preferably has a branched structure, and more preferably has a branched structure branched from the silicon atom at the center.

Specifically, the substituent containing two or more silicon atoms is preferably a group containing two or more structures represented by Formula (BIa).

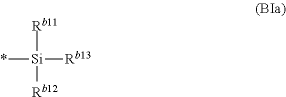

In Formula (BIa), * represents a bonding position, and R^{b11}, R^{b12}, and R^{b13} each independently represent an alkyl group, an alkenyl group, an aryl group, or an alkylene aryl group.

Examples of the alkyl group represented by R^{b11}, R^{b12}, and R^{b13} include a linear alkyl group having 1 to 18 carbon atoms, and a branched or cyclic alkyl group having 3 to 18 carbon atoms. Specific examples of the alkyl group include a methyl group, an ethyl group, a propyl group, a butyl group, an isopropyl group, a tert-butyl group, and a cyclohexyl group.

Examples of the alkenyl group represented by R^{b11}, R^{b12}, and R^{b13} include an alkenyl group having 2 to 12 carbon atoms. Specific examples of the alkenyl group include a vinyl group, a 1-propenyl group, a 1-butenyl group, a 1-methyl-1-propenyl group, a 1-cyclopentenyl group, and a 1-cyclohexenyl group.

Examples of the aryl group represented by R^{b11}, R^{b12}, and R^{b13} include an aryl group having 6 to 12 carbon atoms. Specific examples of the aryl group include a phenyl group, an α-methylphenyl group, and a naphthyl group.

Examples of the alkylene aryl group represented by R^{b11}, R^{b12}, and R^{b13} include an alkylene aryl group having 7 to 30 carbon atoms.

In Formula (BIa), it is preferable that R^{b11}, R^{b12}, and R^{b13} are each independently an alkyl group, it is more preferable that R^{b11}, R^{b12}, and R^{b13} are all the same alkyl group, it is still more preferable that R^{b11}, R^{b12}, and R^{b13} are all alkyl groups having 1 to 4 carbon atoms, and it is particularly preferable that R^{b11}, R^{b12}, and R^{b13} are all methyl groups.

The substituent containing two or more silicon atoms is preferably a group containing three or more structures represented by Formula (BIa), and more preferably a group containing three to six structures represented by Formula (BIa).

The substituent containing two or more silicon atoms is preferably a group represented by Formula (Ba2).

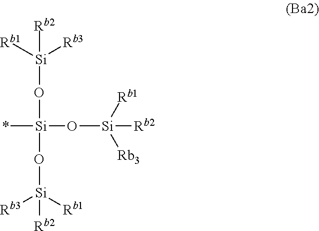

In Formula (Ba2), * represents a bonding position, and R^{b1}, R^{b2}, and R^{b3} each independently represent an alkyl group, an alkenyl group, an aryl group, or an alkylene aryl group.

Examples of the alkyl group represented by R^{b1}, R^{b2}, and R^{b3} include a linear alkyl group having 1 to 18 carbon atoms, and a branched or cyclic alkyl group having 3 to 18 carbon atoms. Specific examples of the alkyl group include a methyl group, an ethyl group, a propyl group, a butyl group, an isopropyl group, a tert-butyl group, and a cyclohexyl group.

Examples of the alkenyl group represented by R^{b1}, R^{b2}, and R^{b3} include an alkenyl group having 2 to 12 carbon atoms. Specific examples of the alkenyl group include a vinyl group, a 1-propenyl group, a 1-butenyl group, a 1-methyl-1-propenyl group, a 1-cyclopentenyl group, and a 1-cyclohexenyl group.

Examples of the aryl group represented by R^{b1}, R^{b2}, and R^{b3} include an aryl group having 6 to 12 carbon atoms. Specific examples of the aryl group include a phenyl group, an α-methylphenyl group, and a naphthyl group.

Examples of the alkylene aryl group represented by R^{b1}, R^{b2}, and R^{b3} include an alkylene aryl group having 7 to 30 carbon atoms.

In Formula (Ba2), it is preferable that R^{b1}, R^{b2}, and R^{b3} are each independently an alkyl group, it is more preferable that R^{b1}, R^{b2}, and R^{b3} are all the same alkyl group, it is still more preferable that R^{b1}, R^{b2}, and R^{b3} are all alkyl groups having 1 to 4 carbon atoms, and it is particularly preferable that R^{b1}, R^{b2}, and R^{b3} are all methyl groups.

Specific examples of the unit represented by Formula (I) include monomers represented by K-1 to K-12. Specific examples of the monomer unit forming the unit having a substituent containing two or more silicon atoms in a side chain are not limited thereto.

In the following structures, n is an integer of 2 to 1000.

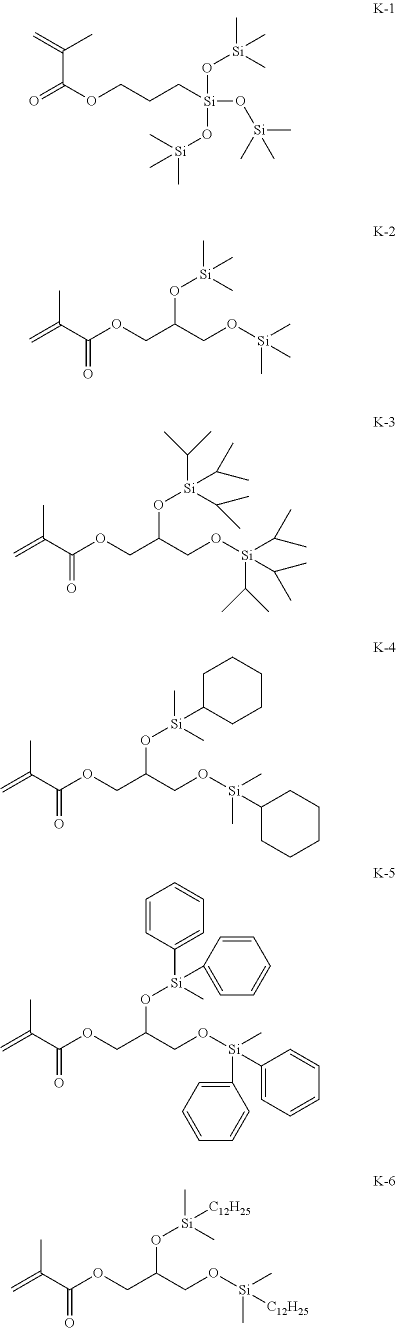

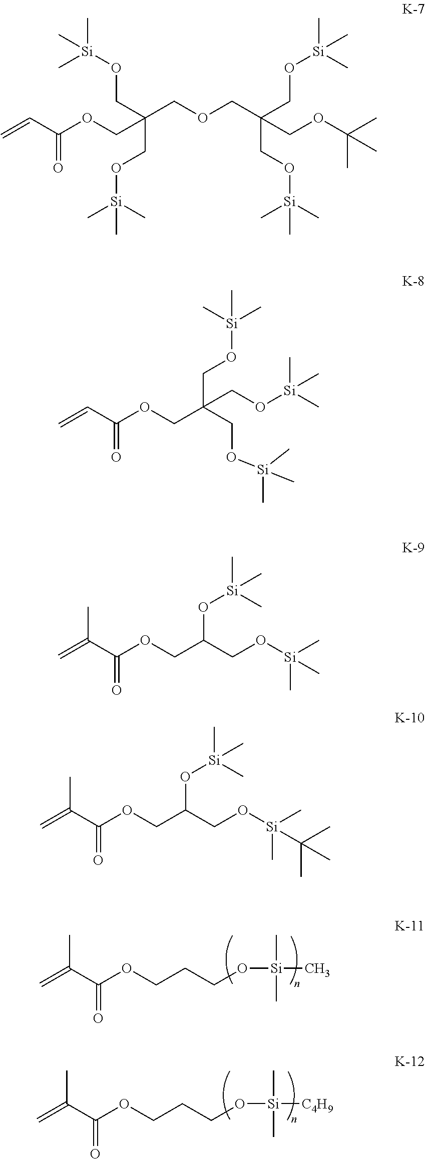

From the viewpoint of obtaining more excellent surface state of a coating film, the unit represented by Formula (I) is preferably a copolymer containing a unit having a substituent containing two or more silicon atoms in a side chain and a unit having a hydrophilic group in a side chain.

The unit having a hydrophilic group in a side chain, which is contained in the unit represented by Formula (I), is preferably a unit represented by Formula (Ba4).

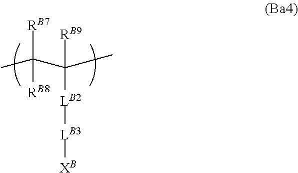

In Formula (Ba4), R^{B7} and R^{B8} each independently represent a hydrogen atom or an alkyl group, R^{B9} represents a hydrogen atom or a monovalent substituent, L^{B2} represents —C(═O)—O—or —C(═O)—NH—, L^{B2} and L^{B3} represent a single bond or a divalent linking group, and X^{B} represents a hydrophilic group.

In the alkyl group represented by R^{B7} and R^{B8}, R⁴ and R⁵ each independently represent a hydrogen atom or an alkyl group.

Examples of the alkyl group represented by R^{B7} and R^{B8} include a linear alkyl group having 1 to 18 carbon atoms, and a branched or cyclic alkyl group having 3 to 18 carbon atoms. Specific examples of the alkyl group include a methyl group, an ethyl group, a propyl group, a butyl group, an isopropyl group, a tert-butyl group, and a cyclohexyl group.

It is preferable that R^{B7} and R^{B8} are both hydrogen atoms.

Examples of the monovalent substituent represented by R^{B9} include an alkyl group, an alkenyl group, and an aryl group. The alkyl group, the alkenyl group, and the aryl group are the same as the alkyl group, the alkenyl group, and the aryl group represented by R^{B11}, R^{B12} and R^{B13}, respectively, and preferred aspects thereof are also the same.

R^{B9} is preferably a hydrogen atom or a methyl group.

The divalent linking group represented by L^{B3} is not particularly limited as long as it is a group capable of linking L^{B2} and X^{B}. Examples of the divalent linking group represented by L^{B3} include an alkylene group. The alkylene group is preferably an alkylene group having 2 to 10 carbon atoms and more preferably an alkylene group having 4 to 8 carbon atoms.

Examples of the hydrophilic group represented by X^{B} include a hydroxyl group, a phosphoric acid group, a polyalkyleneoxy group, and a group consisting of a combination of two or more thereof. Here, examples of the polyalkyleneoxy group include a polyethyleneoxy group, a polypropyleneoxy group, a polybutyleneoxy group, and a group consisting of a combination thereof.

Specific examples of the monomer unit for forming the unit having a hydrophilic group in a side chain include monomers represented by H-1 to H-40. Specific examples of the monomer unit forming the unit having a hydrophilic group in a side chain are not limited thereto.

In the following structures, n and m are each independently an integer of 2 to 100.

In the following structures, the description of “random” means that a plurality of polyalkyleneoxy groups are arranged randomly.

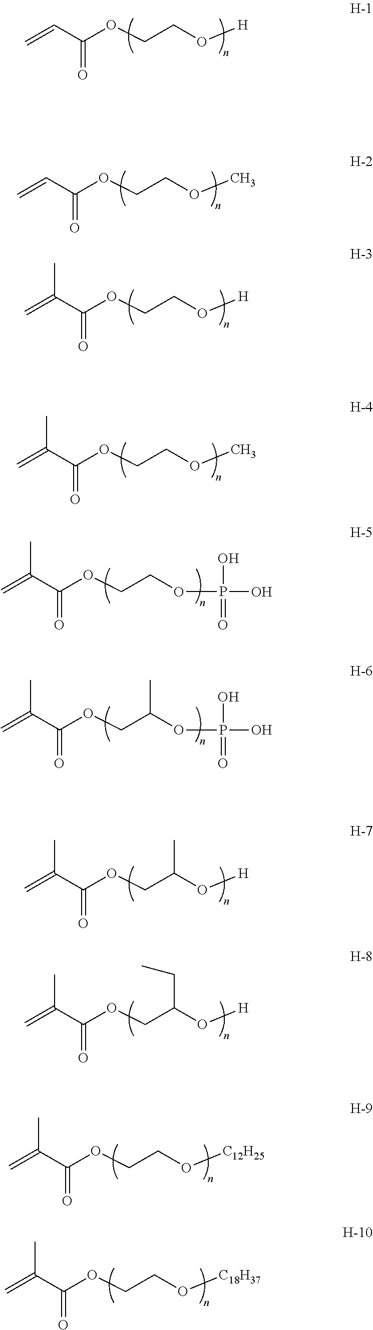

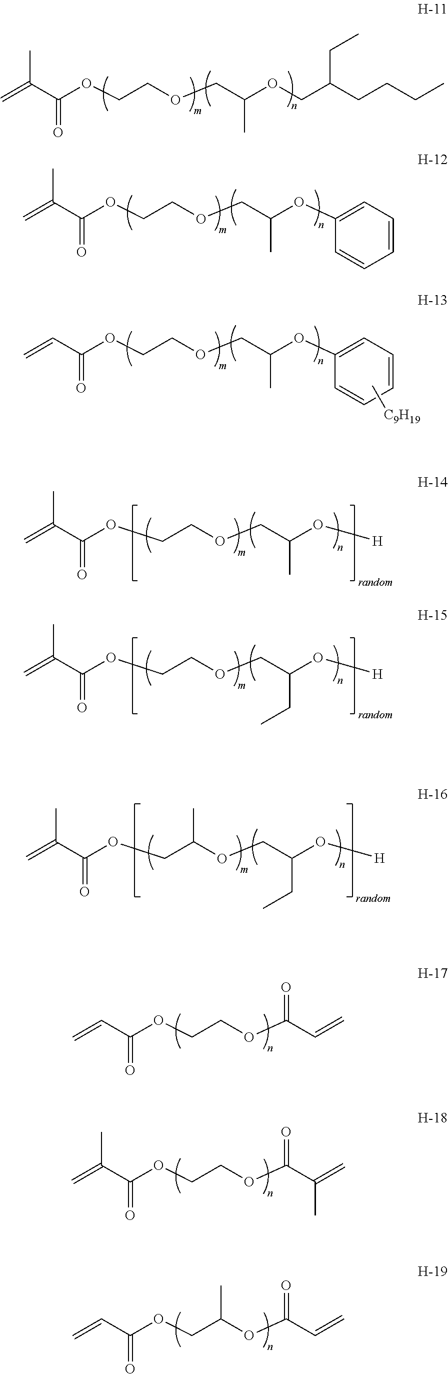

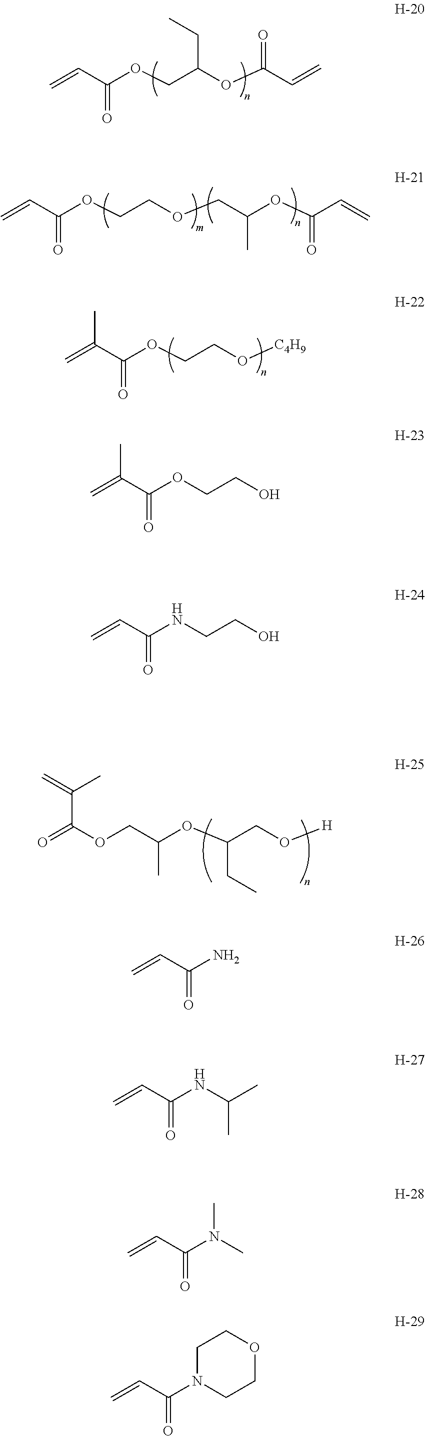

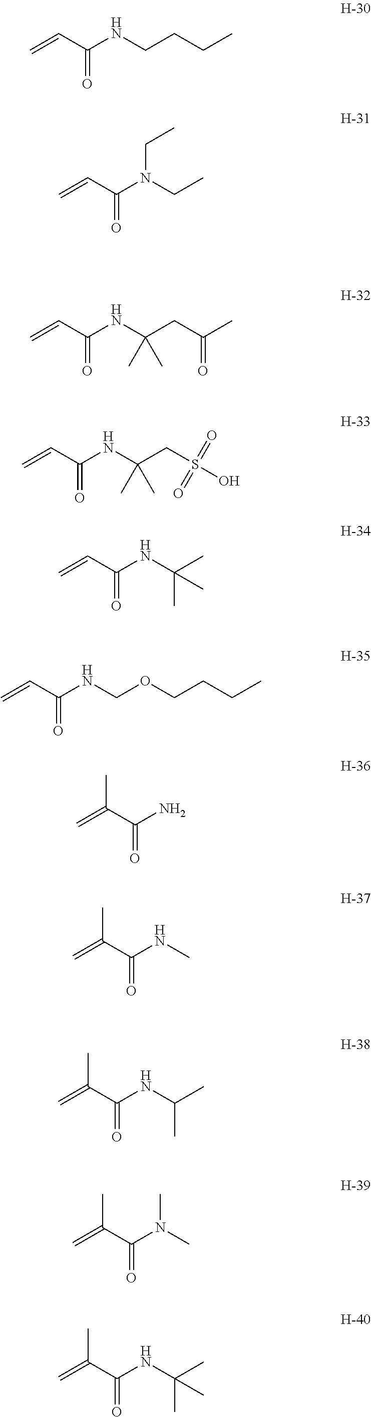

The polymer having a unit represented by Formula (I) (hereinafter, also referred to as a polymer A) may contain one type of unit having a substituent containing two or more silicon atoms in a side chain, or may contain two or more types of units having a substituent containing two or more silicon atoms in a side chain.

In the polymer A, the content of the unit having a substituent containing two or more silicon atoms in a side chain may be 100% by mass, and is preferably 15% by mass to 70% by mass, more preferably 20% by mass to 60% by mass, and still more preferably 25% by mass to 50% by mass, with respect to the mass of the polymer A.

In addition, the polymer A may contain only one type of unit having a hydrophilic group in a side chain or may contain two or more types of units having a hydrophilic group in a side chain.

In the polymer A, the content of the unit having a hydrophilic group in a side chain is preferably 30% by mass to 85% by mass, more preferably 40% by mass to 80% by mass, and still more preferably 50% by mass to 75% by mass with respect to the mass of the polymer A.

The polymer A may further contain other units.

Examples of the other units include a unit having a carboxylic acid group in a side chain. Examples of the unit having a carboxylic acid group in a side chain include (meth)acrylic acid, itaconic acid, and an itaconic acid derivative. It is preferable that the unit having a carboxylic acid group in a side chain is contained as a unit separate from the above-mentioned unit having a hydrophilic group in a side chain.

Examples of the other units include alkyl (meth)acrylate (the number of carbon atoms in the alkyl group is 1 to 24), a styrene derivative, maleic acid anhydride, maleimide anhydride, (meth)acrylonitrile, a vinyl ether derivative, and an alkyl (meth)acrylamide derivative.

In the polymer A, the content of the other units is preferably 0% by mass to 20% by mass with respect to the mass of the polymer A.

From the viewpoint of obtaining an image-recording layer having an excellent surface state, the weight-average molecular weight of the polymer A is preferably 5000 to 100000 and more preferably 8000 to 60000.

Specific examples of the polymer A include BP-1 to BP-10 shown below. Specific examples of the polymer A are not limited thereto.

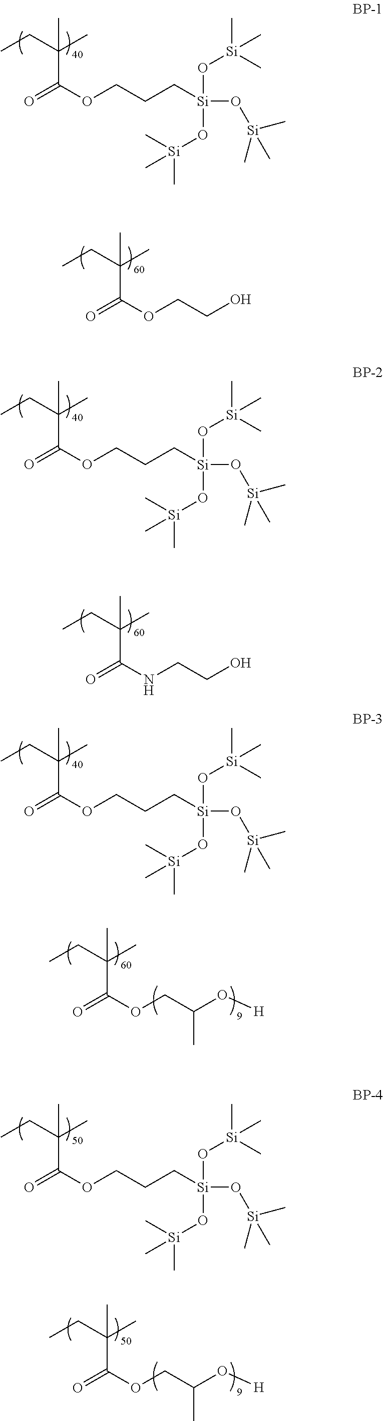

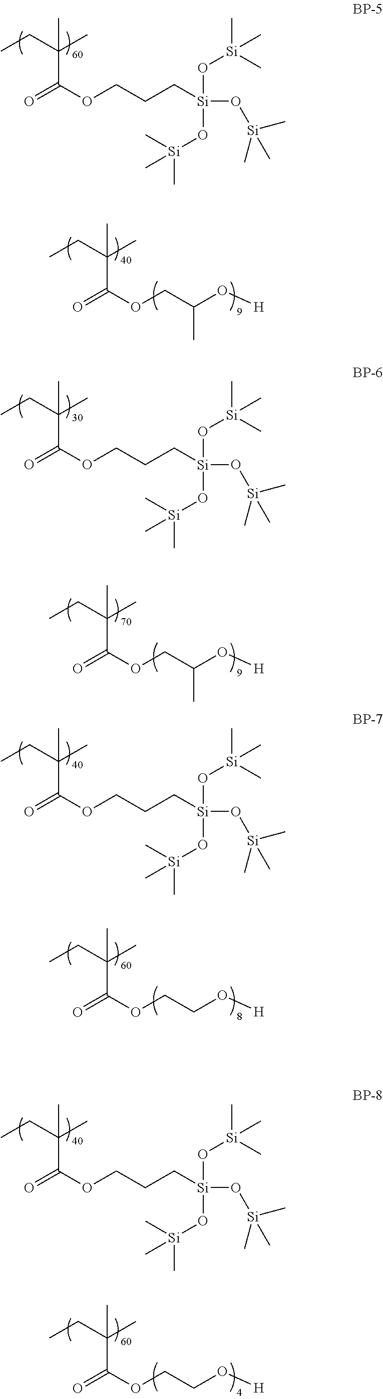

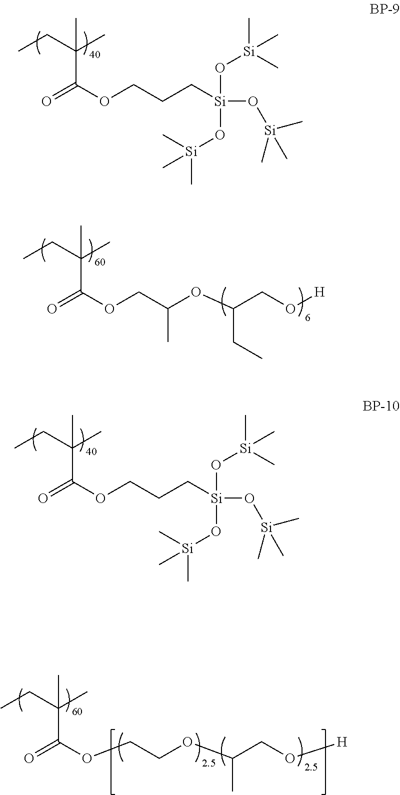

The content of the polymer A is preferably 0.001% by mass to 0.1% by mass and more preferably 0.002% by mass to 0.01% by mass with respect to the total mass of the coating liquid for an image-recording layer.

In the present disclosure, in a case where the term “lithographic printing plate precursor according to the present disclosure” is simply used without any particular specification, this refers to both an aspect having the above-mentioned single-layer image-recording layer and an aspect having the above-mentioned image-recording layer having a multi-layer structure with a lower layer and an upper layer. In addition, in a case where the term “image-recording layer” or the like is simply used without any particular specification, this refers to both the above-mentioned single-layer image-recording layer and the above-mentioned multi-layer image-recording layer.

As a result of extensive studies, the present inventors have found that a lithographic printing plate precursor having an image-recording layer with an excellent surface state of a coating film can be provided by adopting the above-mentioned configuration.

Although the detailed mechanism that brings about the above-mentioned effects is not clear, it is speculated as follows.

In the first embodiment, it is considered that the (meth)acrylic polymer contained in the image-recording layer and having a substituent containing two or more silicon atoms in a side chain is likely to be unevenly distributed on the surface in a case of forming the image-recording layer due to the structure of the side chain, and contributes to the surface smoothness of the image-recording layer.

Furthermore, it is considered that the polymer contained in the image-recording layer and having the unit represented by Formula (I) is likely to be unevenly distributed on the surface in a case of forming the image-recording layer due to the structure of the side chain, and contributes to the surface smoothness of the image-recording layer.

As a result, it is believed that unevenness is less likely to be visually recognized in a case where the surface is visually observed, and an image-recording layer having an excellent surface state of a coating film is obtained.

### Lower Layer

The lower layer of the image-recording layer having a two-layer structure in the present disclosure is preferably a layer containing the positive-working photosensitive resin composition according to the present disclosure.

In addition, it is preferable that the lower layer of the image-recording layer having a two-layer structure in the present disclosure is formed by applying the positive-working photosensitive resin composition according to the present disclosure.

By using the positive-working photosensitive resin composition according to the present disclosure in the lower layer, a printing plate having excellent image formability and printing durability can be obtained.

In addition, by using the positive-working photosensitive resin composition according to the present disclosure in the lower layer, the printing durability is improved.

Although the detailed mechanism by which the above-mentioned effects are obtained is not clear, it is presumed that the film hardness of the resin used in the lower layer is important for printing durability, and therefore it is presumed that the printing durability is improved by using, in the lower layer, the positive-working photosensitive resin composition according to the present disclosure, which has high film hardness due to strong interactions (hydrogen bonds and the like) between binders.

From the viewpoint of improving printing durability, the alkali-soluble resin contained in the lower layer preferably includes at least one selected from an acrylic resin having a sulfonamide group in a side chain, an acrylic resin having a phenolic hydroxyl group in a side chain, or a novolac resin.

It is considered that the inclusion of the alkali-soluble resin in the lower layer contributes to the improvement of the film hardness due to strong interactions (hydrogen bonds and the like) between binders, resulting in better printing durability.

In a case where the positive-working photosensitive resin composition according to the present disclosure is used for the upper layer, it is preferable that the lower layer is also formed of the positive-working photosensitive resin composition according to the present disclosure; however, the lower layer may be formed of a resin composition other than the positive-working photosensitive resin composition according to the present disclosure. In this case, the preferred aspect of the lower layer is the same as the preferred aspect of the upper layer described above.

Above all, it is considered that the surface state of the coating film of the lower layer is further improved by including the polymer having the above-mentioned unit represented by Formula (I) in the lower layer.

### Support

The support used in the positive-working lithographic printing plate precursor according to the present disclosure is not particularly limited as long as it is a dimensionally stable plate-like material that has the necessary strength and durability, and supports similar to those described in paragraphs to of WO2016/047392A can be used.

Among the above-mentioned supports, an aluminum support is particularly preferable, and an aluminum support which has been subjected to a hydrophilization treatment is preferable.

### Undercoat Layer

The positive-working lithographic printing plate precursor according to the present disclosure preferably has an undercoat layer between the support having a hydrophilic surface and the image-recording layer.

Various organic compounds are used as the undercoat layer component, and preferred examples thereof include carboxymethyl cellulose, dextrin, phosphonic acids having an amino group, organic phosphonic acids, organic phosphoric acids, organic phosphinic acids, amino acids, and hydrochlorides of amines having a hydroxy group. In addition, these undercoat layer components may be used alone or in combination of two or more thereof. Details of the compound used in the undercoat layer and the method for forming the undercoat layer are described in paragraphs and of JP2009-175195A, and these descriptions are also applicable to the present disclosure.

For example, the undercoat layer preferably contains at least one selected from the group consisting of a phosphonic acid having an amino group, an organic phosphonic acid, an organic phosphoric acid, an organic phosphinic acid, an amino acid, and a hydrochloride of an amine having a hydroxy group.

The above-mentioned compound may be contained as a partial structure of a polymer, and specific examples thereof include polymers having the following structures.

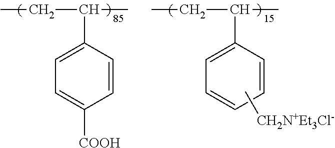

The coating amount of the undercoat layer is preferably 2 mg/m² to 200 mg/m² and more preferably 5 mg/m² to 100 mg/m². In a case where the coating amount of the undercoat layer is within the above-mentioned range, sufficient printing durability can be obtained.

### Back Coating Layer

A back coating layer is provided on the back surface of the support of the positive-working lithographic printing plate precursor according to the present disclosure, as necessary. A coating layer consisting of a metal oxide obtained by hydrolysis and polycondensation of an organic polymer compound described in JP1993-45885A (JP-H05-45885A) and an organic or inorganic metal compound described in JP1994-35174A (JP-H06-35174A) is preferably used as such a back coating layer. Among these coating layers, an alkoxy compound of silicon such as Si(OCH₃)₄, Si(OC₂H₅)₄, Si(OC₃H₇)₄, or Si(OC₄H₉)₄ is inexpensive and easily available, and a coating layer of a metal oxide obtained from the alkoxy compound of silicon is particularly preferable because it is excellent in developer resistance.

### Method of Preparing Lithographic Printing Plate

The method of preparing a lithographic printing plate according to the present disclosure includes, in the following order, an exposure step of imagewise exposing the positive-working lithographic printing plate precursor according to the present disclosure, and a development step of developing the exposed positive-working lithographic printing plate precursor with an alkali aqueous solution having a pH of 8.5 to 13.5.

According to the method of preparing a lithographic printing plate according to the present disclosure, development discrimination is excellent, making it possible to form a fine image and, further, a lithographic printing plate having excellent printing durability can be obtained.

As described above, the method of preparing a lithographic printing plate according to the present disclosure can also be applied to a positive-working lithographic printing plate precursor having any of a single-layer image-recording layer or a multi-layer image-recording layer.

Hereinafter, each step of the method of preparing a lithographic printing plate according to the present disclosure will be described in more detail.

### Exposure Step

The method of preparing a lithographic printing plate according to the present disclosure includes an exposure step of imagewise exposing the positive-working lithographic printing plate precursor according to the present disclosure. The details are the same as those described in paragraphs to of WO2016/047392A.

### Development Step

The method of preparing a lithographic printing plate according to the present disclosure includes a development step of carrying out development using an alkali aqueous solution having a pH of 8.5 to 13.5 (hereinafter, also referred to as a “developer”).

The developer used in the development step is an aqueous solution having a pH of 8.5 to 13.5 and more preferably an alkali aqueous solution having a pH of 12 to 13.5.

In addition, the developer preferably contains a surfactant, and more preferably contains at least an anionic surfactant or a nonionic surfactant. The surfactant contributes to the improvement of treatability.

Any of an anionic, nonionic, cationic, or amphoteric surfactant can be used as the surfactant for use in the developer, but as described above, an anionic or nonionic surfactant is preferable.

As the anionic, nonionic, cationic, and amphoteric surfactants used in the developer in the method of preparing a lithographic printing plate according to the present disclosure, those described in paragraphs to of JP2013-134341A can be used.

In addition, from the viewpoint of stable solubility in water or turbidity, the hydrophile-lipophile balance (HLB) value is preferably 6 or more and more preferably 8 or more.

The surfactant used in the developer is preferably an anionic surfactant or a nonionic surfactant, and particularly preferably an anionic surfactant containing a sulfonic acid or a sulfonate or a nonionic surfactant having an aromatic ring and an ethylene oxide chain.

The surfactants may be used alone or in combination thereof.

The content of the surfactant in the developer is preferably 0.01% by mass to 10% by mass and more preferably 0.01% by mass to 5% by mass.

In order to maintain the pH of the developer at a value of 8.5 to 13.5, the presence of carbonate ions and hydrogen carbonate ions as a buffer can suppress fluctuations in pH even in a case where the developer is used for a long period of time, and can suppress deterioration of developability, generation of developing residues, and the like due to fluctuations in pH. In order to allow carbonate ions and hydrogen carbonate ions to be present in the developer, a carbonate and a hydrogen carbonate may be added to the developer, or carbonate ions and hydrogen carbonate ions may be generated by adding a carbonate or a hydrogen carbonate and then adjusting the pH. The carbonate and the hydrogen carbonate are not particularly limited, and are preferably alkali metal salts. Examples of the alkali metal include lithium, sodium, and potassium, among which sodium is particularly preferable. These may be used alone or in combination of two or more thereof.

The total amount of the carbonate and the hydrogen carbonate is preferably 0.3% by mass to 20% by mass, more preferably 0.5% by mass to 10% by mass, and particularly preferably 1% by mass to 5% by mass with respect to the total mass of the developer. In a case where the total amount of the carbonate and the hydrogen carbonate is 0.3% by mass or more, the developability and the processing ability are not deteriorated, and in a case where the total amount of the carbonate and the hydrogen carbonate is 20% by mass or less, it is unlikely to generate precipitates or crystals and furthermore, the developer is less likely to be gelated upon neutralization in a case of the waste liquid treatment of the developer, thus suppressing the possibility of causing problems in waste liquid treatment.

It is preferable to provide a drying step continuously or discontinuously after the development step. The drying can be carried out with hot air, infrared rays, far infrared rays, or the like.

As an automatic treatment machine that is suitably used in the method of preparing a lithographic printing plate according to the present disclosure, a device having a development section and a drying section is used, in which a positive-working lithographic printing plate precursor is subjected to development and gum treatment in a development tank, and then dried in the drying section to obtain a lithographic printing plate.

In addition, for the purpose of improving printing durability or the like, the printing plate after development can also be heated under very strong conditions. The heating treatment is also referred to as a post-heating step.

The heating temperature in the post-heating step is preferably in a range of 200° C. to 500° C. from the viewpoint of achieving desired image reinforcing action and suppressing thermal decomposition of the image area.

The lithographic printing plate thus obtained is applied to an offset printing press and is suitably used for printing a large number of sheets.

### EXAMPLES

Hereinafter, the present disclosure will be described in more detail with reference to Examples. The materials, amounts to be used, proportions, treatment contents, treatment procedures, and the like shown in Examples given hereinafter can be appropriately modified without departing from the spirit and scope of the embodiments of the present disclosure. Therefore, it is to be understood that the scope of the embodiments of the present disclosure is not limited to the following specific examples. In the present examples, “parts” and “%” refer to “parts by mass” and “% by mass”, respectively, unless otherwise specified.

### Examples 1 to 27 and Comparative Examples 1 to 11

### Preparation of Specific Compound

The specific compound according to the present disclosure is available as a commercially available product. The specific compound is commercially available in the form of a reagent or a chemical product from, for example, Tokyo Chemical Industry Co., Ltd., FUJIFILM Wako Pure Chemical Corporation, Sigma-Aldrich Co., LLC, and Kanto Chemical Co., Inc.

### Preparation of Support

A 0.3 mm thick aluminum alloy plate made of material IS was subjected to the treatments shown in the following (A-a) to (A-k) to produce a support for a lithographic printing plate. A washing treatment with water was carried out between all the treatment steps, and liquid draining was carried out using a nip roller after the washing treatment with water.

### (A-a) Mechanical Roughening Treatment (Brush Grain Method)

While supplying a suspension of pumice (specific gravity of 1.1 g/cm³) as an abrasive slurry to the surface of the aluminum plate, a mechanical roughening treatment was carried out using a rotating bundle brush.

The median diameter (μm) of the abrasive material was set to 30 μm, the number of brushes was set to 4, and the rotation speed (rpm: revolutions per minute, the same applies hereinafter) of the brushes was set to 250 rpm. The bundle brush was made of 6. 10 nylon, with bristles having a diameter of 0.3 mm and a length of 50 mm. The brush was configured in such a manner that holes were drilled into a stainless steel cylinder having a diameter of φ 300 mm and bristles were planted densely in the holes. The distance between two support rollers (diameter of q 200 mm) below the bundle brush was 300 mm. The bundle brush was pressed down until the load of the drive motor for rotating the brush was 10 kW or more than the load applied before the bundle brush was pressed down against the aluminum plate. The rotation direction of the brush was the same as the movement direction of the aluminum plate.

### (A-b) Alkali Etching Treatment

An aqueous solution of caustic soda having a caustic soda concentration of 26% by mass and an aluminum ion concentration of 6.5% by mass was sprayed onto the aluminum plate obtained above using a spray tube at a temperature of 70° C., thereby carrying out an etching treatment. Then, washing with water was carried out by means of spraying. The amount of dissolved aluminum was 10 g/m².

### (A-c) Desmutting Treatment in Acidic Aqueous Solution

Next, a desmutting treatment was carried out in a nitric acid aqueous solution. As the nitric acid aqueous solution used in the desmutting treatment, the waste liquid of nitric acid used in electrochemical roughening of the subsequent step was used. The liquid temperature was 35° C. The desmutting treatment was carried out for 3 seconds by spraying the desmutting liquid.

### (A-d) Electrochemical Roughening Treatment

An electrochemical roughening treatment was continuously carried out using nitric acid electrolysis and a 60 Hz AC voltage. In this treatment, an electrolytic solution was used which was prepared by adding aluminum nitrate to an aqueous solution of 10.4 g/L nitric acid at a temperature of 35° C. such that the aluminum ion concentration was adjusted to 4.5 g/L. Using a trapezoidal rectangular waveform AC having a time tp, until the current value reached a peak from zero, of 0.8 msec and a duty ratio of 1:1 as the AC power source waveform, the electrochemical roughening treatment was carried out using a carbon electrode as a counter electrode. Ferrite was used as an auxiliary anode. The current density was 30 A/dm² in terms of the peak value of current, and 5% of the current flowing from the power source was split off to the auxiliary anode. The quantity of electricity (C/dm²) was 185° C./dm², which is the total quantity of electricity in a case where the aluminum plate was the anode. Then, washing with water was carried out by means of spraying.

### (A-e) Alkali Etching Treatment

An aqueous solution of caustic soda having a caustic soda concentration of 5% by mass and an aluminum ion concentration of 0.5% by mass was sprayed onto the aluminum plate obtained above using a spray tube at a temperature of 50° C., thereby carrying out an etching treatment. Then, washing with water was carried out by means of spraying. The amount of dissolved aluminum was 0.5 g/m².

### (A-f) Desmutting Treatment in Acidic Aqueous Solution

Next, a desmutting treatment was carried out in a sulfuric acid aqueous solution. The sulfuric acid aqueous solution used for the desmutting treatment had a sulfuric acid concentration of 170 g/L and an aluminum ion concentration of 5 g/L. The liquid temperature was 30° C. The desmutting treatment was carried out for 3 seconds by spraying the desmutting liquid.

### (A-g) Electrochemical Roughening Treatment

An electrochemical roughening treatment was continuously carried out using hydrochloric acid electrolysis and a 60 Hz AC voltage. An electrolytic solution was used which was prepared by adding aluminum chloride to an aqueous solution of 6.2 g/L hydrochloric acid at a liquid temperature of 35° C. such that the aluminum ion concentration was adjusted to 4.5 g/L. Using a trapezoidal rectangular waveform AC having a time tp, until the current value reached a peak from zero, of 0.8 msec and a duty ratio of 1:1, the electrochemical roughening treatment was carried out using a carbon electrode as a counter electrode. Ferrite was used as an auxiliary anode.

The current density was 25 A/dm² in terms of the peak value of current, and the quantity of electricity (C/dm²) in the hydrochloric acid electrolysis was 63° C./dm² which is the total quantity of electricity in a case where the aluminum plate was the anode. Then, washing with water was carried out by means of spraying.

### (A-h) Alkali Etching Treatment

An aqueous solution of caustic soda having a caustic soda concentration of 5% by mass and an aluminum ion concentration of 0.5% by mass was sprayed onto the aluminum plate obtained above using a spray tube at a temperature of 50° C., thereby carrying out an etching treatment. Then, washing with water was carried out by means of spraying. The amount of dissolved aluminum was 0.1 g/m².

### (A-i) Desmutting Treatment in Acidic Aqueous Solution

Next, a desmutting treatment was carried out in a sulfuric acid aqueous solution. Specifically, the desmutting treatment was carried out using a waste liquid generated in the anodization treatment step (170 g/L sulfuric acid aqueous solution containing dissolved aluminum ions at a concentration of 5 g/L) at a liquid temperature of 35° C. for 4 seconds. The desmutting treatment was carried out for 3 seconds by spraying the desmutting liquid.

### (A-j) Anodization Treatment

An anodization treatment was carried out using an anodization device for a two-stage power supply electrolytic treatment method (first and second electrolytic units each having a length of 6 m, first and second power feed units each having a length of 3 m, and first and second power feed electrode parts each having a length of 2.4 m). Sulfuric acid was used as the electrolytic solution supplied to the first and second electrolytic units. All the electrolytic solutions had a sulfuric acid concentration of 50 g/L (containing 0.5% by mass of aluminum ions) and a temperature of 20° C. Then, washing with water was carried out by means of spraying.

### (A-k) Silicate Treatment

In order to ensure hydrophilicity of a non-image area, the non-image area was subjected to a silicate treatment by dipping the non-image area in 2.5% by mass of a sodium silicate aqueous solution No. 3 at 50° C. for 7 seconds. An attachment amount of Si was 10 mg/m². Then, washing with water was carried out by means of spraying.

### Formation of Undercoat Layer

An undercoat layer coating liquid 1 shown below was applied onto the support prepared as described above and then dried at 80° C. for 15 seconds to provide an undercoat layer to obtain a support. The coating amount after drying was 15 mg/m².

Undercoat layer coating liquid 1
Copolymer having a weight-average molecular weight of 28000 given below: 0.3 parts
Methanol: 100 parts
Water: 1 part

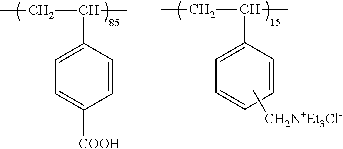

In the above chemical formulae, a subscript in parenthesis represents the content (% by mass) of each unit.

### Formation of Image-Recording Layer

A coating liquid composition (I) for forming a lower layer having the following composition is applied onto the obtained support using a wire bar, and dried in a drying oven at 150° C. for 40 seconds so that the coating amount is 1.0 g/m², thereby providing a lower layer. A coating liquid composition (II) for forming an upper layer having the following composition is applied using a wire bar to provide an upper layer on the surface of the lower layer. After the application of the upper layer, the resulting structure is dried at 150° C. for 40 seconds to obtain a lithographic printing plate precursor in which a combined coating amount of the lower layer and the upper layer is 1.2 g/m².

Coating liquid composition (I) for forming lower layer
N-(4-aminosulfonylphenyl) methacrylamide/acrylonitrile/methyl methacrylate copolymer (copolymerization ratio: 32/36/32, weight-average molecular weight: 50000): 2.5 parts
m,p-Cresol novolac: 0.4 parts
Specific compounds or comparative compounds having the following structures (compounds shown in Tables 1 to 7): in the amounts shown in Tables 1 to 7
Infrared absorber (IR dye (I): the structure given below): 0.2 parts
Tetrahydrophthalic anhydride (THPA): 0.3 parts or not contained (described in Tables 1 to 7)
p-Toluenesulfonic acid (p-TsO): 0.02 parts or not contained (described in Tables 1 to 7)
3-Methoxy-4-diazodiphenylamine hexafluorophosphate: 0.1 parts
Ethyl violet with the counter ion changed to 6-hydroxynaphthalene sulfonic acid: 0.15 parts
Fluorine-based surfactant (MEGAFACE F-780F, manufactured by DIC Corporation, see (e-1) for structure): 0.01 parts
Silicone-based surface conditioner (BYK-300, manufactured by BYK Japan KK): 0.01 parts or not contained (described in Tables 1 to 7)
Siloxane-based surface conditioner (additive (e-2) given below): 0.01 parts or not contained (described in Tables 1 to 7)
Methyl ethyl ketone: 30 parts
1-Methoxy-2-butyrolactone: 15 parts
γ-Butyrolactone: 15 parts

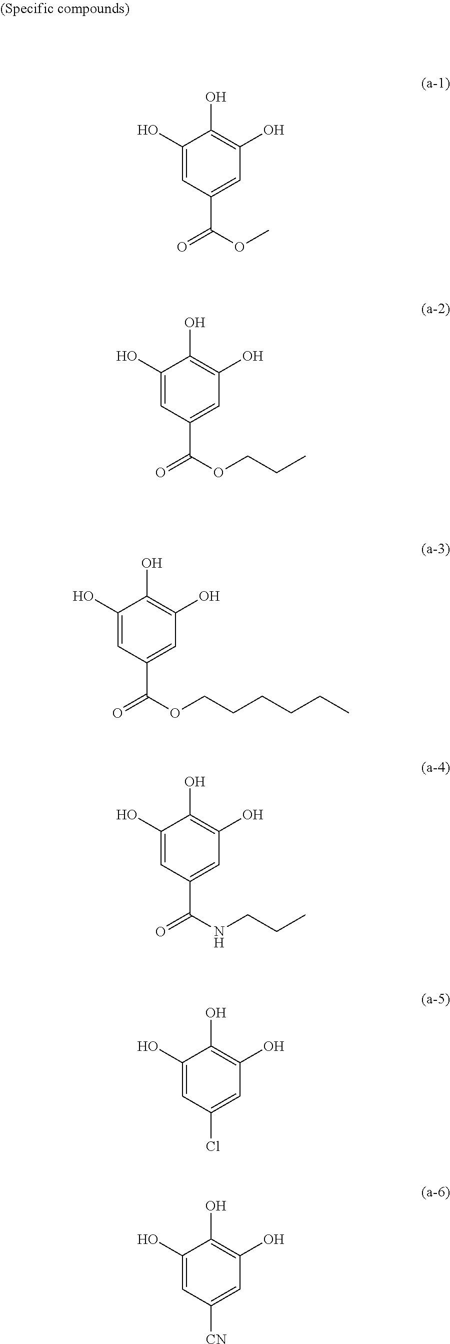 [SMILES: COC(=O)c1cc(O)c(O)c(O)c1 ; CCCOC(=O)c1cc(O)c(O)c(O)c1 ; CCCCCCOC(=O)c1cc(O)c(O)c(O)c1 ; CCCNC(=O)c1cc(O)c(O)c(O)c1 ; Oc1cc(Cl)cc(O)c1O ; N#Cc1cc(O)c(O)c(O)c1]

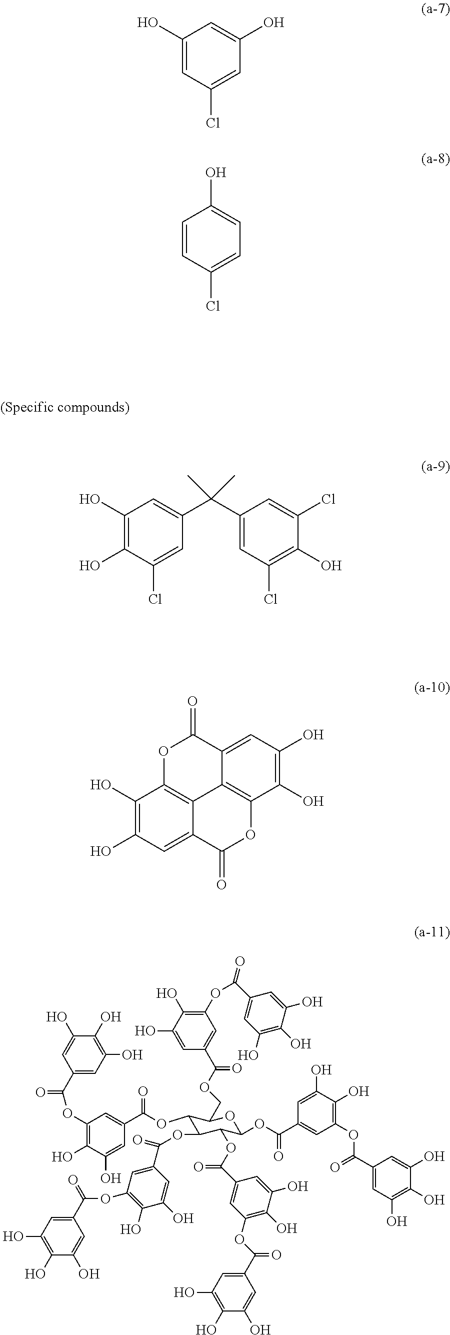 [SMILES: Oc1cc(O)cc(Cl)c1 ; Oc1ccc(Cl)cc1 ; CC(C)(c1cc(O)c(O)c(Cl)c1)c1cc(Cl)c(O)c(Cl)c1 ; O=c1oc2c(O)c(O)cc3c(=O)oc4c(O)c(O)cc1c4c23 ; O=C(OCC1OC(OC(=O)c2cc(O)c(O)c(OC(=O)c3cc(O)c(O)c(O)c3)c2)C(OC(=O)c2cc(O)c(O)c(OC(=O)c3cc(O)c(O)c(O)c3)c2)C(OC(=O)c2cc(O)c(O)c(OC(=O)c3cc(O)c(O)c(O)c3)c2)C1OC(=O)c1cc(O)c(O)c(OC(=O)c2cc(O)c(O)c(O)c2)c1)c1cc(O)c(O)c(OC(=O)c2cc(O)c(O)c(O)c2)c1]

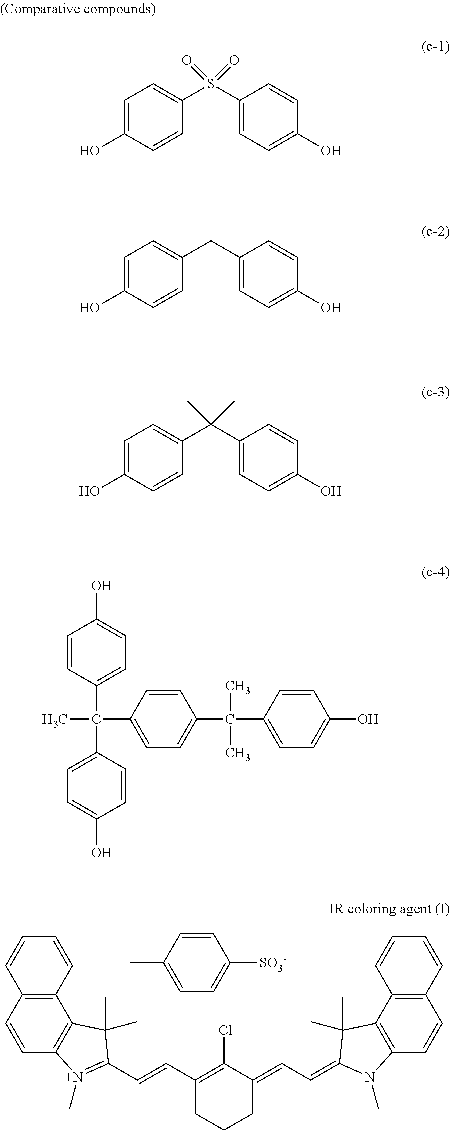

Coating liquid composition (II) for forming upper layer
Novolac resin (m-cresol/p-cresol/phenol=3/2/5, Mw: 8000): 0.68 parts
Ethyl methacrylate/isobutyl methacrylate/methacrylic acid copolymer (copolymerization ratio: 50/20/30, weight-average molecular weight: 42000): 0.16 parts
Infrared absorber (IR dye (I): the structure given above): 0.045 parts
Methyl ethyl ketone: 15.0 parts
1-Methoxy-2-propanol: 30.0 parts
Sulfonate A (the structure given below: b-1): 0.16 parts
Sulfonate B (the structure given below: b-2): 0.16 parts
Fluorine-based surfactant (MEGAFACE F-782F, manufactured by DIC Corporation, see (d-1) for structure): 0.01 parts or not contained
Siloxane-based surfactant (compounds having the structures (d-2) to (d-6) given below): 0.01 parts or not contained
Additives having the structures given below (compounds described in Tables 1 to 7): in the amounts (parts) described in Tables 1 to 7

In the following structural formulae, the compositional ratio of each unit is expressed as % by weight in a case where the total amount of each unit is 100% by mass. MW represents a weight-average molecular weight.

| | | |
|---|---|---|
| 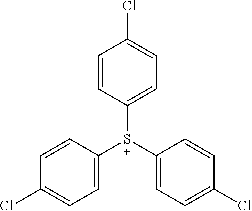 [SMILES: Clc1ccc([S+](c2ccc(Cl)cc2)c2ccc(Cl)cc2)cc1] | 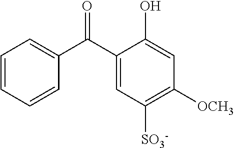 | (b1) |

Sulfonate A

| | | |
|---|---|---|
| 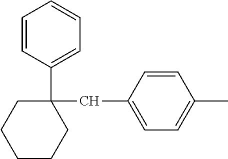 [SMILES: Cc1ccc(CC2(c3ccccc3)CCCCC2)cc1] | 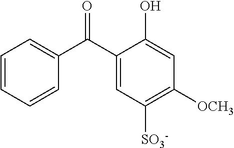 | (b-2) |

Sulfonate B

| | | | | | |
|---|---|---|---|---|---|
| 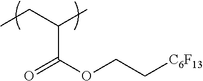 | / | 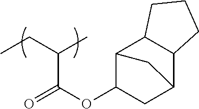 | / | 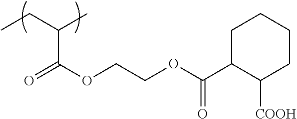 | (d-1) |

| | | | |
|---|---|---|---|
| 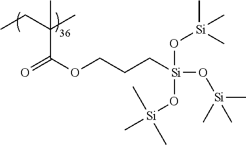 | 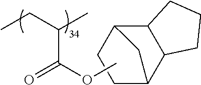 | 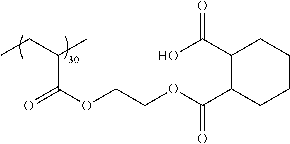 | (d-2) |
| | | MW: 20000 | |
| 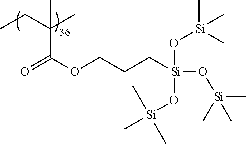 | 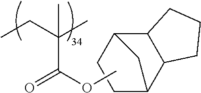 | 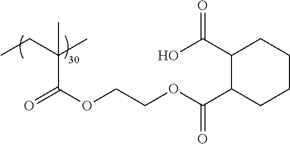 | (d-3) |
| | | MW: 26000 | |
| 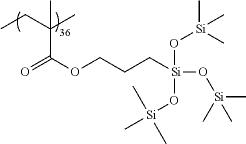 | 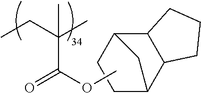 | 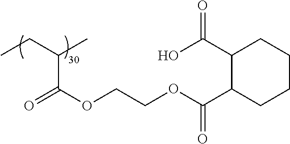 | (d-4) |
| | | MW: 23000 | |
| 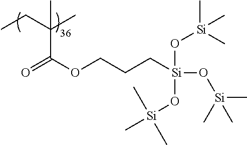 | 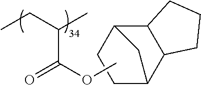 | 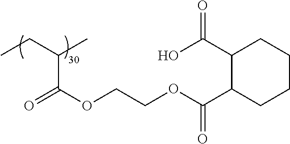 | (d-5) |
| | | MW: 15000 | |
| 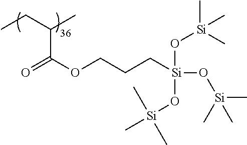 | 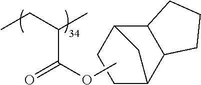 | 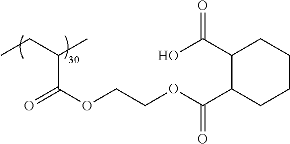 | (d-6) |
| | | MW: 20600 | |
| 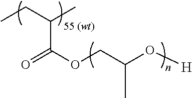 | 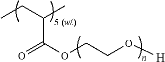 | 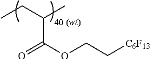 | (e-1) |

Weight-average molecular weight: 29,400

| | | |
|---|---|---|
| 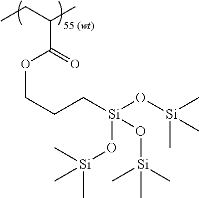 | 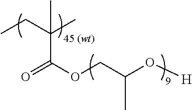 | (e-2) |

Weight-average molecular weight: 25,000

| | | |
|---|---|---|
| 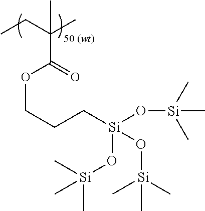 | 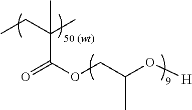 | (e-3) |

Weight-average molecular weight: 28,800

In Tables 1 to 7, the numerical value of the content indicates parts by mass, and “-” indicates that the compound is not contained.

The following evaluations were carried out using the obtained lithographic printing plate precursor of each of Examples and Comparative Examples, and the results are shown in Tables 1 to 7 which will be given later.

### Evaluation of Dissolution Resistance of Image Area and Development Time of Non-Image Area

The positive-working lithographic printing plate precursor in each of Examples and Comparative Examples is subjected to imagewise drawing of a test pattern using Trendsetter VX manufactured by Creo Company at a beam intensity of 9 W and a drum rotation speed of 150 rpm.

Thereafter, the positive-working lithographic printing plate precursor is immersed in a development bath containing a developer XP-D (diluted to have a conductivity of 42 mS/cm) manufactured by FUJIFILM Corporation, and the time until the image area starts to dissolve at a development temperature of 28° C. and the time taken for the non-image area to be developed are measured.

The time until the image area starts to dissolve is defined as the time until the measured value of the optical density (OD value) in the image area decreases by 0.05 from the measured value of the optical density in the image area before the development treatment. In addition, the immersion time in a case where the difference between the measured value of the optical density in the non-image area and the measured value of the optical density of the aluminum support is 0.02 or less is defined as the non-image area development time. In both cases, the optical density is measured using a spectrophotometer SpectroEye manufactured by GretagMacbeth Company.

The longer the time until the image area starts to dissolve, the better the resistance to the alkali aqueous solution. Furthermore, the shorter the non-image area development time, the better the solubility in an alkali aqueous solution in the non-image area, and the better the alkali aqueous solution developability (highlight reproducibility). Therefore, in the positive-working lithographic printing plate precursor, it is evaluated that the longer the image area dissolution start time, the shorter the non-image area development time, and the greater the difference between the image area dissolution start time and the non-image area development time, the more excellent the developability. In each of the following tables, the above-mentioned difference is described as “development discrimination”.

It can be said that the shorter the non-image area development time, the more excellent the suppression of the above-mentioned residual color.

The results are shown in Tables 1 to 7.

### Evaluation of Scratch Resistance

The surface of the obtained lithographic printing plate precursor is scratched by applying a load to a sapphire needle (tip diameter: 1.0 mm) using a scratch tester manufactured by HEIDON Co., Ltd. Thereafter, the lithographic printing plate precursor is subjected to imagewise exposure using Trendsetter 3244 manufactured by Creo Company at a beam intensity of 9.0 W and a drum rotation speed of 150 rpm.

The development is carried out using a PS processor LP940H manufactured by FUJIFILM Corporation, in which a developer DT-2 (diluted at 1:8) manufactured by FUJIFILM Corporation and a FINISHER FG-1 (diluted at 1:1) manufactured by FUJIFILM Corporation are charged, with the liquid temperature kept at 30° C. and the development time being 12 s. The conductivity of the developer at this time is set to 43 mS/cm.

The lithographic printing plate after development was visually observed, and the maximum load (g) at which no scratches were observed was taken as the value of scratch resistance. It is evaluated that the larger the numerical value, the more excellent the scratch resistance.

It is evaluated that a scratch resistance of 7 or more is a level at which there is no problem in practical use, and a scratch resistance of 8 or more is preferable and a scratch resistance of 10 or more is more preferable.

The results are shown in Tables 1 to 7 which will be given later.

### Evaluation of Printing Durability

The positive-working lithographic printing plate precursor in each of Examples and Comparative Examples is subjected to imagewise drawing of a test pattern using Trendsetter manufactured by Creo Company at a beam intensity of 9 W and a drum rotation speed of 150 rpm.

The non-image area is developed using a PS processor LP940H manufactured by FUJIFILM Corporation, in which a developer XP-D (diluted to have a conductivity of 43 mS/cm) manufactured by FUJIFILM Corporation is charged, at a development temperature of 30° C. for a development time of 12 seconds. This is continuously printed using a printing press LITHRONE manufactured by Komori Corporation. As the ink, Toyo Tokuren black ink containing calcium carbonate is used as a model of a low-grade material. In this case, the number of sheets on which printing can be carried out while maintaining a sufficient ink density is visually measured to evaluate the printing durability. It is evaluated that the greater the number of sheets, the more excellent the printing durability. The results are shown in Tables 1 to 7.

### Evaluation of Surface State of Coating Film

The prepared lithographic printing plate precursor is processed into a size of 40 cm×62 cm. The surface of the obtained sample on the outermost layer side is visually observed under irradiation with a white lamp of 750 to 1500 Lux, and the surface state is evaluated according to the following standards. The results are shown in Tables 1 to 7.

### Standards

A: No unevenness is visually recognized on the entire surface.
B: Weak unevenness is partially visually recognized.
C: Weak unevenness is partially visually recognized in a wider region than in B.

### Evaluation of Ink Adhesion Properties

The positive-working lithographic printing plate precursor in each of Examples and Comparative Examples is loaded into a plate material supply device, continuously exposed in a fully automatic manner, developed using the above-mentioned developer, and discharged into a stocker. The resolution at the time of exposure is 2,400 dpi (dots per inch, the number of dots per inch=2.54 cm) and 175 lines, and the halftone dots are changed in a range of 0.5% to 99.5%. The obtained lithographic printing plate is subjected to printing using a printing press Model No. R201 manufactured by Manroland AG and DAICURE ABILIO manufactured by DIC Graphics Corporation as an ink, and it is visually confirmed that there is no region where the ink is not adhered to the printing portion, and the number of printed sheets required up to that point is taken as an indicator of ink adhesion properties. It is evaluated that the fewer the number of printed sheets required for ink to adhere, the better the ink adhesion properties. The evaluation was carried out according to the following evaluation standards, and the evaluation results are shown in Tables 1 to 7.

### Evaluation Standards

1: The number of printed sheets required for ink to adhere is 15 or less.
2: The number of printed sheets required for ink to adhere is more than 15 and 30 or less.
3: The number of printed sheets required for ink to adhere is more than 30.

TABLE 1

| | | Compound | Example 1 | Example 2 | Example 3 | Example 4 | Example 5 | Example 6 |
|---|---|---|---|---|---|---|---|---|
| Lower layer | Additive | BYK-300 | — | — | — | — | — | — |
| | | (e-2) | — | — | — | — | — | — |
| | | p-TsO | 0.1 | 0.1 | 0.1 | 0.1 | 0.1 | 0.1 |
| | | THPA | 0.3 | 0.3 | 0.3 | 0.3 | 0.3 | 0.3 |
| | Specific compound | (a-1) | 0.3 | — | — | — | — | — |
| | | (a-2) | — | 0.3 | 0.15 | 0.06 | 0.6 | 1.5 |
| | | (a-3) | — | — | — | — | — | — |
| Upper layer | Additive | (b-1) | 0.16 | 0.16 | 0.16 | 0.16 | 0.16 | 0.16 |
| | | (b-2) | 0.16 | 0.16 | 0.16 | 0.16 | 0.16 | 0.16 |
| | | (d-1) | 0.2 | 0.2 | 0.2 | 0.2 | 0.2 | 0.2 |
| | | (e-1) | 0.01 | 0.01 | 0.01 | 0.01 | 0.01 | 0.01 |
| | | (e-2) | — | — | — | — | — | — |

| | | | | | | | |
|---|---|---|---|---|---|---|---|
| Evaluation of | 1. Film loss start time (sec) in | 27 | 30 | 35 | 42 | 26 | 19 |
| performance | non-exposed portion (image area) | | | | | | |
| | 2. Development completion time (sec) in | 9 | 10 | 15 | 26 | 6 | 3 |
| | exposed portion (non-image area) | | | | | | |
| | Development discrimination | 18 | 20 | 20 | 16 | 20 | 16 |
| | (sec: difference between 1 and 2: 2 − 1) | | | | | | |
| | Scratch resistance | 10 | 10 | 10 | 10 | 10 | 8 |
| | Printing durability | 1 | 1 | 1 | 1 | 1 | 2 |
| | Surface state of coating film | B | B | B | B | B | B |
| | Ink adhesion properties | 2 | 2 | 2 | 2 | 2 | 2 |

TABLE 2

| | | Compound | Example 7 | Example 8 | Example 9 | Example 10 | Example 11 |
|---|---|---|---|---|---|---|---|
| Lower layer | Additive | BYK-300 | 0.01 | — | — | — | — |
| | | (e-2) | — | — | — | — | — |
| | | p-TsO | 0.1 | 0.1 | 0.1 | 0.1 | 0.1 |
| | | THPA | 0.3 | 0.3 | 0.3 | 0.3 | 0.3 |
| | Specific compound | (a-1) | — | — | — | — | — |
| | | (a-2) | 0.3 | — | — | — | — |
| | | (a-3) | — | 0.3 | — | — | — |
| | | (a-4) | — | — | 0.3 | — | — |
| | | (a-5) | — | — | — | 0.3 | — |
| | | (a-6) | — | — | — | — | 0.3 |
| Upper layer | Additive | (b-1) | 0.16 | 0.16 | 0.16 | 0.16 | 0.16 |
| | | (b-2) | 0.16 | 0.16 | 0.16 | 0.16 | 0.16 |
| | | (d-1) | 0.2 | 0.2 | 0.2 | 0.2 | 0.2 |
| | | (e-1) | 0.01 | 0.01 | 0.01 | 0.01 | 0.01 |
| | | (e-2) | — | — | — | — | — |

| | | | | | | |
|---|---|---|---|---|---|---|
| Evaluation of | 1. Film loss start time (sec) in | 19 | 34 | 29 | 27 | 25 |
| performance | non-exposed portion (image area) | | | | | |
| | 2. Development completion time (sec) | 3 | 15 | 13 | 13 | 13 |
| | in exposed portion (non-image area) | | | | | |
| | Development discrimination | 16 | 19 | 16 | 14 | 12 |
| | (sec: difference between 1 and 2: 2 − 1) | | | | | |
| | Scratch resistance | 8 | 10 | 8 | 8 | 8 |
| | Printing durability | 2 | 1 | 2 | 2 | 2 |
| | Surface state of coating film | B | B | B | B | B |
| | Ink adhesion properties | 2 | 2 | 2 | 2 | 2 |

TABLE 3

| | | Compound | Example 12 | Example 13 | Example 14 | Example 15 | Example 16 |
|---|---|---|---|---|---|---|---|
| Lower layer | Additive | BYK-300 | — | — | — | — | — |
| | | (e-2) | — | — | — | — | — |
| | | p-TsO | 0.1 | 0.1 | 0.1 | 0.1 | 0.1 |
| | | THPA | 0.3 | 0.3 | 0.3 | 0.3 | 0.3 |
| | Specific compound | (a-7) | 0.3 | — | — | — | — |
| | | (a-8) | — | 0.3 | — | — | — |
| | | (a-9) | — | — | 0.3 | — | — |
| | | (a-10) | — | — | — | 0.3 | — |
| | | (a-11) | — | — | — | — | 0.3 |
| Upper layer | Additive | (b-1) | 0.16 | 0.16 | 0.16 | 0.16 | 0.16 |
| | | (b-2) | 0.16 | 0.16 | 0.16 | 0.16 | 0.16 |
| | | (d-1) | 0.2 | 0.2 | 0.2 | 0.2 | 0.2 |
| | | (e-1) | 0.01 | 0.01 | — | 0.01 | 0.01 |
| | | (e-2) | — | — | 0.01 | — | — |

| | | | | | | |
|---|---|---|---|---|---|---|
| Evaluation of | 1. Film loss start time (sec) in | 24 | 20 | 29 | 30 | 32 |
| performance | non-exposed portion (image area) | | | | | |
| | 2. Development completion time | 15 | 13 | 14 | 13 | 13 |
| | (sec) in exposed portion | | | | | |
| | (non-image area) | | | | | |
| | Development discrimination | 9 | 7 | 15 | 17 | 19 |
| | (sec: difference between 1 and 2: | | | | | |
| | 2 − 1) | | | | | |
| | Scratch resistance | 8 | 8 | 8 | 10 | 10 |
| | Printing durability | 2 | 2 | 2 | 1 | 1 |
| | Surface state of coating film | B | B | B | B | B |
| | Ink adhesion properties | 2 | 2 | 2 | 2 | 2 |

TABLE 4

| | | Compound | Example 17 | Example 18 | Example 19 | Example 20 | Example 21 |
|---|---|---|---|---|---|---|---|
| Lower layer | Additive | BYK-300 | — | — | — | — | — |
| | | (e-2) | — | — | — | 0.01 | — |
| | | p-TsO | — | 0.1 | 0.1 | 0.1 | — |
| | | THPA | — | 0.3 | 0.3 | 0.3 | — |
| | Specific compound | (a-2) | 0.3 | 0.3 | 0.3 | 0.3 | 0.3 |
| Upper layer | Additive | (b-1) | 0.16 | — | 0.16 | 0.16 | 0.16 |
| | | (b-2) | 0.16 | 0.16 | — | 0.16 | 0.16 |
| | | (d-1) | 0.2 | 0.2 | 0.2 | 0.2 | 0.2 |
| | | (d-2) | — | — | — | — | — |
| | | (e-1) | 0.01 | 0.01 | 0.01 | 0.01 | — |
| | | (e-2) | — | — | — | — | 0.01 |

| | | | | | | |
|---|---|---|---|---|---|---|
| Evaluation of | 1. Film loss start time (sec) in non-exposed | 24 | 23 | 30 | 30 | 30 |
| performance | portion (image area) | | | | | |
| | 2. Development completion time (sec) in | 8 | 7 | 11 | 10 | 10 |
| | exposed portion (non-image area) | | | | | |
| | Development discrimination | 16 | 16 | 19 | 20 | 20 |
| | (sec: difference between 1 and 2: 2 − 1) | | | | | |
| | Scratch resistance | 8 | 7 | 10 | 10 | 11 |
| | Printing durability | 2 | 2 | 1 | 1 | 1 |
| | Surface state of coating film | B | B | B | A | A |
| | Ink adhesion properties | 2 | 2 | 3 | 2 | 2 |

TABLE 5

| | | | Example | Example | Example | Example | Example | Example |
|---|---|---|---|---|---|---|---|---|
| | | Compound | 22 | 23 | 24 | 25 | 26 | 27 |
| Lower layer | Additive | BYK-300 | — | — | — | — | — | — |
| | | (e-2) | 0.01 | 0.01 | 0.01 | 0.01 | 0.01 | — |
| | | (e-3) | — | — | — | — | — | 0.01 |
| | | p-TsO | 0.1 | 0.1 | 0.1 | 0.1 | 0.1 | 0.1 |
| | | THPA | 0.3 | 0.3 | 0.3 | 0.3 | 0.3 | 0.3 |
| | Specific | (a-2) | 0.3 | 0.3 | 0.3 | 0.3 | 0.3 | 0.3 |
| | compound | | | | | | | |
| Upper layer | Additive | (b-1) | 0.16 | 0.16 | 0.16 | 0.16 | 0.16 | 0.16 |
| | | (b-2) | 0.16 | 0.16 | 0.16 | 0.16 | 0.16 | 0.16 |
| | | (d-1) | 0.2 | — | — | — | — | — |
| | | (d-2) | — | 0.2 | — | — | — | — |
| | | (d-3) | — | — | 0.2 | — | — | — |
| | | (d-4) | — | — | — | 0.2 | — | — |
| | | (d-5) | — | — | — | — | 0.2 | — |
| | | (d-6) | — | — | — | — | — | 0.2 |
| | | (e-1) | — | — | — | — | — | — |
| | | (e-2) | 0.01 | 0.01 | 0.01 | 0.01 | 0.01 | — |
| | | (e-3) | — | — | — | — | — | 0.01 |
| | Specific | (a-2) | — | — | — | — | — | 0.01 |
| | compound | | | | | | | |

| | | | | | | | |
|---|---|---|---|---|---|---|---|
| Evaluation of | 1. Film loss start time (sec) in | 30 | 30 | 30 | 30 | 30 | 24 |
| performance | non-exposed portion (image area) | | | | | | |
| | 2. Development completion time (sec) | 8 | 8 | 8 | 8 | 8 | 8 |
| | in exposed portion (non-image area) | | | | | | |
| | Development discrimination | 22 | 22 | 22 | 22 | 22 | 16 |
| | (sec: difference between 1 and 2: 2 − | | | | | | |
| | 1) | | | | | | |
| | Scratch resistance | 11 | 11 | 11 | 11 | 11 | 8 |
| | Printing durability | 1 | 1 | 1 | 1 | 1 | 2 |
| | Surface state of coating film | A | A | A | A | A | A |
| | Ink adhesion properties | 2 | 2 | 2 | 2 | 2 | 2 |

TABLE 6

| | | | Comparative | Comparative | Comparative | Comparative | Comparative |
|---|---|---|---|---|---|---|---|
| | | Compound | Example 1 | Example 2 | Example 3 | Example 4 | Example 5 |
| Lower layer | Additive | BYK-300 | — | 0.01 | — | — | — |
| | | (e-2) | — | 0.01 | 0.01 | 0.01 | — |
| | | p-TsO | — | — | — | — | — |
| | | THPA | — | 0.3 | 0.3 | 0.3 | — |
| | Comparative | (c-1) | — | 0.3 | — | — | — |
| | compound | (c-2) | — | — | 0.3 | — | — |
| | | (c-3) | — | — | — | 0.3 | — |
| | | (c-4) | — | — | — | — | 0.3 |
| Upper layer | Additive | (b-1) | 0.16 | 0.16 | 0.16 | 0.16 | 0.16 |
| | | (b-2) | 0.16 | 0.16 | 0.16 | 0.16 | 0.16 |
| | | (d-1) | 0.2 | 0.2 | 0.2 | 0.2 | 0.2 |
| | | (d-2) | — | — | — | — | — |
| | | (e-1) | 0.01 | 0.01 | 0.01 | 0.01 | 0.01 |
| | | (e-2) | — | — | — | — | — |

| | | | | | | |
|---|---|---|---|---|---|---|
| Evaluation of | 1. Film loss start time (sec) in | 25 | 18 | 22 | 30 | 32 |
| performance | non-exposed portion (image area) | | | | | |
| | 2. Development completion time (sec) | 20 | 5 | 20 | 29 | 30 |
| | in exposed portion (non-image area) | | | | | |
| | Development discrimination | 5 | 13 | 2 | 1 | 2 |
| | (sec: difference between 1 and 2: 2 − | | | | | |
| | 1) | | | | | |
| | Scratch resistance | 3 | 7 | 5 | 5 | 5 |
| | Printing durability | 3 | 2 | 3 | 3 | 3 |
| | Surface state of coating film | B | C | B | B | B |
| | Ink adhesion properties | 2 | 2 | 2 | 2 | 2 |

TABLE 7

| | | | Comparative | Comparative | Comparative | Comparative | Comparative | Comparative |
|---|---|---|---|---|---|---|---|---|
| | | Compound | Example 6 | Example 7 | Example 8 | Example 9 | Example 10 | Example 11 |
| Lower layer | Additive | BYK-300 | — | — | — | — | — | — |
| | | (e-2) | 0.01 | 0.01 | 0.01 | 0.01 | 0.01 | — |
| | | (e-3) | — | — | — | — | — | 0.01 |
| | | p-TsO | 0.1 | 0.1 | 0.1 | 0.1 | 0.1 | 0.1 |
| | | THPA | 0.3 | 0.3 | 0.3 | 0.3 | 0.3 | 0.3 |
| | Comparative | (c-1) | 0.3 | 0.3 | 0.3 | 0.3 | 0.3 | 0.3 |
| | compound | (c-2) | — | — | — | — | — | — |
| | | (c-3) | — | — | — | — | — | — |
| | | (c-4) | — | — | — | — | — | — |
| Upper layer | Additive | (b-1) | 0.16 | 0.16 | 0.16 | 0.16 | 0.16 | 0.16 |
| | | (b-2) | 0.16 | 0.16 | 0.16 | 0.16 | 0.16 | 0.16 |
| | | (d-1) | 0.2 | — | — | — | — | — |
| | | (d-2) | — | 0.2 | — | — | — | — |
| | | (d-3) | — | — | 0.2 | — | — | — |
| | | (d-4) | — | — | — | 0.2 | — | — |
| | | (d-5) | — | — | — | — | 0.2 | — |
| | | (d-6) | — | — | — | — | — | 0.2 |
| | | (e-1) | — | — | — | — | — | — |
| | | (e-2) | 0.01 | 0.01 | 0.01 | 0.01 | 0.01 | — |
| | | (e-3) | — | — | — | — | — | 0.01 |
| | Comparative | (c-1) | — | — | — | — | — | 0.01 |
| | compound | | | | | | | |

| | | | | | | | |
|---|---|---|---|---|---|---|---|
| Evaluation of | 1. Film loss start time (sec) | 18 | 18 | 18 | 18 | 18 | 16 |
| performance | in non-exposed portion | | | | | | |
| | (image area) | | | | | | |
| | 2. Development completion | 5 | 5 | 5 | 5 | 5 | 5 |
| | time (sec) in exposed portion | | | | | | |
| | (non-image area) | | | | | | |
| | Development discrimination | 13 | 13 | 13 | 13 | 13 | 13 |
| | (sec: difference between 1 | | | | | | |
| | and 2: 2 − 1) | | | | | | |
| | Scratch resistance | 7 | 7 | 7 | 7 | 7 | 8 |
| | Printing durability | 2 | 2 | 2 | 2 | 2 | 2 |
| | Surface state of coating film | A | A | A | A | A | A |
| | Ink adhesion properties | 2 | 2 | 2 | 2 | 2 | 2 |

From the results in Tables 1 to 7, it can be seen that the positive-working lithographic printing plate precursor of each Example according to the present disclosure provides a high-definition image with good development discrimination, and a lithographic printing plate to be obtained has excellent printing durability and scratch resistance.

From the results of Example 2, the results of using propyl gallate of the specific compound (a-2) are good. In addition, from the results of Examples 2 to 6, it can be seen that good results are obtained regardless of the content of the specific compound.

In addition, from the comparison of Example 2 with Examples 21 and 22 to 26, it can be seen that, in a case of using a fluorine-based surfactant or a siloxane-based surface conditioner, and a surfactant, particularly, in a case of using a fluorine-based surfactant or a siloxane-based surfactant and the siloxane-based surface conditioner (e-2) in the upper layer, particularly the development discrimination and scratch resistance are improved.

From the comparison of Comparative Examples 2 to 7 with each Example, it can be seen that, even in a case of a compound having a phenolic hydroxyl group in one molecule, each Example is more favorable in development discrimination, printing durability of the lithographic printing plate, and scratch resistance of the image area, as compared with the positive-working lithographic printing plate precursor having an image-recording layer consisting of a positive-working photosensitive resin composition in which a compound having no electron-withdrawing group or a compound having an electron-withdrawing group other than the specific electron-withdrawing group is used.

### Examples 28 to 55 and Comparative Examples 12 to 22

The lithographic printing plate precursor of Example 28 was obtained in the same manner as in Example 1, except that the coating liquid composition (III) for forming a lower layer was changed to the following coating liquid composition (II) for forming a lower layer, and the evaluation was carried out in the same manner as in Example 1. In addition, lithographic printing plate precursors of Examples 28 to 55 and Comparative Examples 12 to 22 were prepared containing the formulations of the coating liquid composition (III) for forming a lower layer and the coating liquid composition (II) for forming an upper layer in accordance with the types and amounts shown in Tables 8 to 14 which will be given later.

In Tables 8 to 14, the numerical value of the content indicates parts by mass, and “-” indicates that the compound is not contained.

The same evaluations as in Example 1 were carried out using the obtained lithographic printing plate precursor of each of Examples and Comparative Examples. The results are shown in Tables 8 to 14 which will be given later.

### Coating Liquid Composition (III) for Forming Lower Layer

N-(4-aminosulfonylphenyl) methacrylamide/acrylonitrile/methyl methacrylate copolymer (copolymerization ratio: 32/36/32, weight-average molecular weight: 50000): 2.5 parts
m,p-Cresol novolac: 0.4 parts
Specific compounds or comparative compounds having the structures given below) (compounds shown in Tables 8 to 14): in the amounts shown in Tables 8 to 14
Infrared absorber (IR dye (I): the structure given below): 0.2 parts
Tetrahydrophthalic anhydride (THPA): 0.3 parts or not contained (described in Tables 8 to 14)
p-Toluenesulfonic acid (p-TsO): 0.02 parts or not contained (described in Tables 8 to 14)
3-Methoxy-4-diazodiphenylamine hexafluorophosphate: 0.1 parts
Ethyl violet with the counter ion changed to 6-hydroxynaphthalene sulfonic acid: 0.15 parts
Fluorine-based surfactant (MEGAFACE F-780F, manufactured by DIC Corporation, see (e-1) for structure): 0.01 parts
Silicone-based surface conditioner (BYK-300, manufactured by BYK Japan KK): 0.01 parts or not contained (described in Tables 8 to 14)
Siloxane-based surface conditioner (additive (e-2) given below): 0.01 parts or not contained (described in Tables 8 to 14)
Methyl ethyl ketone: 30 parts
1-Methoxy-2-propanol: 15 parts
γ-Butyrolactone: 15 parts

TABLE 8

| | | Compound | Example 28 | Example 29 | Example 30 | Example 31 | Example 32 | Example 33 |
|---|---|---|---|---|---|---|---|---|
| Lower layer | Additive | BYK-300 | — | — | — | — | — | — |
| | | (e-2) | — | — | — | — | — | — |
| | | p-TsO | 0.1 | 0.1 | 0.1 | 0.1 | 0.1 | 0.1 |
| | | THPA | 0.3 | 0.3 | 0.3 | 0.3 | 0.3 | 0.3 |
| | Specific compound | (a-1) | 0.3 | — | — | — | — | — |
| | | (a-2) | — | 0.3 | 0.15 | 0.06 | 0.6 | 1.5 |
| | | (a-3) | — | — | — | — | — | — |
| Upper layer | Additive | (b-1) | 0.16 | 0.16 | 0.16 | 0.16 | 0.16 | 0.16 |
| | | (b-2) | 0.16 | 0.16 | 0.16 | 0.16 | 0.16 | 0.16 |
| | | (d-1) | 0.2 | 0.2 | 0.2 | 0.2 | 0.2 | 0.2 |
| | | (e-1) | 0.01 | 0.01 | 0.01 | 0.01 | 0.01 | 0.01 |
| | | (e-2) | — | — | — | — | — | — |

| | | | | | | | |
|---|---|---|---|---|---|---|---|
| Evaluation of | 1. Film loss start time (sec) in | 27 | 30 | 35 | 42 | 26 | 19 |
| | non-exposed portion (image area) | | | | | | |
| performance | 2. Development completion time | 9 | 10 | 15 | 26 | 6 | 3 |
| | (sec) in exposed portion | | | | | | |
| | (non-image area) | | | | | | |
| | Development discrimination | 18 | 20 | 20 | 16 | 20 | 16 |
| | (sec: difference between 1 and 2: | | | | | | |
| | 2 − 1) | | | | | | |
| | Scratch resistance | 10 | 10 | 10 | 10 | 10 | 8 |
| | Printing durability | 1 | 1 | 1 | 1 | 1 | 2 |
| | Surface state of coating film | B | B | B | B | B | B |
| | Ink adhesion properties | 2 | 2 | 2 | 2 | 2 | 2 |

TABLE 9

| | | Compound | Example 34 | Example 35 | Example 36 | Example 37 | Example 38 |
|---|---|---|---|---|---|---|---|
| Lower layer | Additive | BYK-300 | 0.01 | — | — | — | — |
| | | (e-2) | — | — | — | — | — |
| | | p-TsO | 0.1 | 0.1 | 0.1 | 0.1 | 0.1 |
| | | THPA | 0.3 | 0.3 | 0.3 | 0.3 | 0.3 |
| | Specific compound | (a-1) | — | — | — | — | — |
| | | (a-2) | 0.3 | — | — | — | — |
| | | (a-3) | — | 0.3 | — | — | — |
| | | (a-4) | — | — | 0.3 | — | — |
| | | (a-5) | — | — | — | 0.3 | — |
| | | (a-6) | — | — | — | — | 0.3 |
| Upper layer | Additive | (b-1) | 0.16 | 0.16 | 0.16 | 0.16 | 0.16 |
| | | (b-2) | 0.16 | 0.16 | 0.16 | 0.16 | 0.16 |
| | | (d-1) | 0.2 | 0.2 | 0.2 | 0.2 | 0.2 |
| | | (e-1) | 0.01 | 0.01 | 0.01 | 0.01 | 0.01 |
| | | (e-2) | — | — | — | — | — |

| | | | | | | |
|---|---|---|---|---|---|---|
| Evaluation of | 1. Film loss start time (sec) in | 19 | 34 | 29 | 27 | 25 |
| performance | non-exposed portion (image area) | | | | | |
| | 2. Development completion time (sec) | 3 | 15 | 13 | 13 | 13 |
| | in exposed portion (non-image area) | | | | | |
| | Development discrimination | 16 | 19 | 16 | 14 | 12 |
| | (sec: difference between 1 and 2: 2 − 1) | | | | | |
| | Scratch resistance | 8 | 10 | 8 | 8 | 8 |
| | Printing durability | 2 | 1 | 2 | 2 | 2 |
| | Surface state of coating film | B | B | B | B | B |
| | Ink adhesion properties | 2 | 2 | 2 | 2 | 2 |

TABLE 10

| | | Compound | Example 39 | Example 40 | Example 41 | Example 42 | Example 44 |
|---|---|---|---|---|---|---|---|
| Lower layer | Additive | BYK-300 | — | — | — | — | — |
| | | (e-2) | — | — | — | — | — |
| | | p-TsO | 0.1 | 0.1 | 0.1 | 0.1 | 0.1 |
| | | THPA | 0.3 | 0.3 | 0.3 | 0.3 | 0.3 |
| | Specific compound | (a-7) | 0.3 | — | — | — | — |
| | | (a-8) | — | 0.3 | — | — | — |
| | | (a-9) | — | — | 0.3 | — | — |
| | | (a-10) | — | — | — | 0.3 | — |
| | | (a-11) | — | — | — | — | 0.3 |
| Upper layer | Additive | (b-1) | 0.16 | 0.16 | 0.16 | 0.16 | 0.16 |
| | | (b-2) | 0.16 | 0.16 | 0.16 | 0.16 | 0.16 |
| | | (d-1) | 0.2 | 0.2 | 0.2 | 0.2 | 0.2 |
| | | (e-1) | 0.01 | 0.01 | — | 0.01 | 0.01 |
| | | (e-2) | — | — | 0.01 | — | — |

| | | | | | | |
|---|---|---|---|---|---|---|
| Evaluation of | 1. Film loss start time (sec) in non-exposed | 24 | 20 | 29 | 30 | 32 |
| performance | portion (image area) | | | | | |
| | 2. Development completion time (sec) in | 15 | 13 | 14 | 13 | 13 |
| | exposed portion (non-image area) | | | | | |
| | Development discrimination | 9 | 7 | 15 | 17 | 19 |
| | (sec: difference between 1 and 2: 2 − 1) | | | | | |
| | Scratch resistance | 8 | 8 | 8 | 10 | 10 |
| | Printing durability | 2 | 2 | 2 | 1 | 1 |
| | Surface state of coating film | B | B | B | B | B |
| | Ink adhesion properties | 2 | 2 | 2 | 2 | 2 |

TABLE 11

| | | Compound | Example 45 | Example 46 | Example 47 | Example 48 | Example 49 |
|---|---|---|---|---|---|---|---|
| Lower layer | Additive | BYK-300 | — | — | — | — | — |
| | | (e-2) | — | — | — | 0.01 | — |
| | | p-TsO | — | 0.1 | 0.1 | 0.1 | — |
| | | THPA | — | 0.3 | 0.3 | 0.3 | — |
| | Specific compound | (a-2) | 0.3 | 0.3 | 0.3 | 0.3 | 0.3 |
| Upper layer | Additive | (b-1) | 0.16 | — | 0.16 | 0.16 | 0.16 |
| | | (b-2) | 0.16 | 0.16 | — | 0.16 | 0.16 |
| | | (d-1) | 0.2 | 0.2 | 0.2 | 0.2 | 0.2 |
| | | (d-2) | — | — | — | — | — |
| | | (e-1) | 0.01 | 0.01 | 0.01 | 0.01 | — |
| | | (e-2) | — | — | — | — | 0.01 |

| | | | | | | |
|---|---|---|---|---|---|---|
| Evaluation of | 1. Film loss start time (sec) in non-exposed | 24 | 23 | 30 | 30 | 30 |
| performance | portion (image area) | | | | | |
| | 2. Development completion time (sec) in | 8 | 7 | 11 | 10 | 10 |
| | exposed portion (non-image area) | | | | | |
| | Development discrimination | 16 | 16 | 19 | 20 | 20 |
| | (sec: difference between 1 and 2: 2 − 1) | | | | | |
| | Scratch resistance | 8 | 7 | 10 | 10 | 11 |
| | Printing durability | 2 | 2 | 1 | 1 | 1 |
| | Surface state of coating film | B | B | B | A | A |
| | Ink adhesion properties | 2 | 2 | 3 | 2 | 2 |

TABLE 12

| | | | Example | Example | Example | Example | Example | Example |
|---|---|---|---|---|---|---|---|---|
| | | Compound | 50 | 51 | 52 | 53 | 54 | 55 |
| Lower layer | Additive | BYK-300 | — | — | — | — | — | — |
| | | (e-2) | 0.01 | 0.01 | 0.01 | 0.01 | 0.01 | — |
| | | (e-3) | — | — | — | — | — | 0.01 |
| | | p-TsO | 0.1 | 0.1 | 0.1 | 0.1 | 0.1 | 0.1 |
| | | THPA | 0.3 | 0.3 | 0.3 | 0.3 | 0.3 | 0.3 |
| | Specific | (a-2) | 0.3 | 0.3 | 0.3 | 0.3 | 0.3 | 0.3 |
| | compound | | | | | | | |
| Upper layer | Additive | (b-1) | 0.16 | 0.16 | 0.16 | 0.16 | 0.16 | 0.16 |
| | | (b-2) | 0.16 | 0.16 | 0.16 | 0.16 | 0.16 | 0.16 |
| | | (d-1) | 0.2 | — | — | — | — | — |
| | | (d-2) | — | 0.2 | — | — | — | — |
| | | (d-3) | — | — | 0.2 | — | — | — |
| | | (d-4) | — | — | — | 0.2 | — | — |
| | | (d-5) | — | — | — | — | 0.2 | — |
| | | (d-6) | — | — | — | — | — | 0.2 |
| | | (e-1) | — | — | — | — | — | — |
| | | (e-2) | 0.01 | 0.01 | 0.01 | 0.01 | 0.01 | — |
| | | (e-3) | — | — | — | — | — | 0.01 |
| | Specific | (a-2) | — | — | — | — | — | 0.01 |
| | compound | | | | | | | |

| | | | | | | | |
|---|---|---|---|---|---|---|---|
| Evaluation of | 1. Film loss start time (sec) in | 30 | 30 | 30 | 30 | 30 | 24 |
| performance | non-exposed portion (image area) | | | | | | |
| | 2. Development completion time (sec) | 8 | 8 | 8 | 8 | 8 | 8 |
| | in exposed portion (non-image area) | | | | | | |
| | Development discrimination | 22 | 22 | 22 | 22 | 22 | 16 |
| | (sec: difference between 1 and 2: 2 − | | | | | | |
| | 1) | | | | | | |
| | Scratch resistance | 11 | 11 | 11 | 11 | 11 | 8 |
| | Printing durability | 1 | 1 | 1 | 1 | 1 | 2 |
| | Surface state of coating film | A | A | A | A | A | A |
| | Ink adhesion properties | 2 | 2 | 2 | 2 | 2 | 2 |

TABLE 13

| | | | Comparative | Comparative | Comparative | Comparative | Comparative |
|---|---|---|---|---|---|---|---|
| | | Compound | Example 12 | Example 13 | Example 14 | Example 15 | Example 16 |
| Lower layer | Additive | BYK-300 | — | 0.01 | — | — | — |
| | | (e-2) | — | 0.01 | 0.01 | 0.01 | — |
| | | p-TsO | — | — | — | — | — |
| | | THPA | — | 0.3 | 0.3 | 0.3 | — |
| | Comparative | (c-1) | — | 0.3 | — | — | — |
| | compound | (c-2) | — | — | 0.3 | — | — |
| | | (c-3) | — | — | — | 0.3 | — |
| | | (c-4) | — | — | — | — | 0.3 |
| Upper layer | Additive | (b-1) | 0.16 | 0.16 | 0.16 | 0.16 | 0.16 |
| | | (b-2) | 0.16 | 0.16 | 0.16 | 0.16 | 0.16 |
| | | (d-1) | 0.2 | 0.2 | 0.2 | 0.2 | 0.2 |
| | | (d-2) | — | — | — | — | — |
| | | (e-1) | 0.01 | 0.01 | 0.01 | 0.01 | 0.01 |
| | | (e-2) | — | — | — | — | — |

| | | | | | | |
|---|---|---|---|---|---|---|
| Evaluation of | 1. Film loss start time (sec) in | 25 | 18 | 22 | 30 | 32 |
| performance | non-exposed portion (image area) | | | | | |
| | 2. Development completion time (sec) | 20 | 5 | 20 | 29 | 30 |
| | in exposed portion (non-image area) | | | | | |
| | Development discrimination | 5 | 13 | 2 | 1 | 2 |
| | (sec: difference between 1 and 2: 2 − | | | | | |
| | 1) | | | | | |
| | Scratch resistance | 3 | 7 | 5 | 5 | 5 |
| | Printing durability | 3 | 2 | 3 | 3 | 3 |
| | Surface state of coating film | B | C | B | B | B |
| | Ink adhesion properties | 2 | 2 | 2 | 2 | 2 |

TABLE 14

| | | | Comparative | Comparative | Comparative | Comparative | Comparative | Comparative |
|---|---|---|---|---|---|---|---|---|
| | | Compound | Example 17 | Example 18 | Example 19 | Example 20 | Example 21 | Example 22 |
| Lower layer | Additive | BYK-300 | — | — | — | — | — | — |
| | | (e-2) | 0.01 | 0.01 | 0.01 | 0.01 | 0.01 | — |
| | | (e-3) | — | — | — | — | — | 0.01 |
| | | p-TsO | 0.1 | 0.1 | 0.1 | 0.1 | 0.1 | 0.1 |
| | | THPA | 0.3 | 0.3 | 0.3 | 0.3 | 0.3 | 0.3 |
| | Comparative | (c-1) | 0.3 | 0.3 | 0.3 | 0.3 | 0.3 | 0.3 |
| | compound | (c-2) | — | — | — | — | — | — |
| | | (c-3) | — | — | — | — | — | — |
| | | (c-4) | — | — | — | — | — | — |
| Upper layer | Additive | (b-1) | 0.16 | 0.16 | 0.16 | 0.16 | 0.16 | 0.16 |
| | | (b-2) | 0.16 | 0.16 | 0.16 | 0.16 | 0.16 | 0.16 |
| | | (d-1) | 0.2 | — | — | — | — | — |
| | | (d-2) | — | 0.2 | — | — | — | — |
| | | (d-3) | — | — | 0.2 | — | — | — |
| | | (d-4) | — | — | — | 0.2 | — | — |
| | | (d-5) | — | — | — | — | 0.2 | — |
| | | (d-6) | — | — | — | — | — | 0.2 |
| | | (e-1) | — | — | — | — | — | — |
| | | (e-2) | 0.01 | 0.01 | 0.01 | 0.01 | 0.01 | — |
| | | (e-3) | — | — | — | — | — | 0.01 |
| | Comparative | (c-1) | — | — | — | — | — | 0.01 |
| | compound | | | | | | | |

| | | | | | | | |
|---|---|---|---|---|---|---|---|
| Evaluation of | 1. Film loss start time (sec) | 18 | 18 | 18 | 18 | 18 | 16 |
| performance | in non-exposed portion | | | | | | |
| | (image area) | | | | | | |
| | 2. Development completion | 5 | 5 | 5 | 5 | 5 | 5 |
| | time (sec) in exposed portion | | | | | | |
| | (non-image area) | | | | | | |
| | Development discrimination | 13 | 13 | 13 | 13 | 13 | 13 |
| | (sec: difference between 1 | | | | | | |
| | and 2: 2 − 1) | | | | | | |
| | Scratch resistance | 7 | 7 | 7 | 7 | 7 | 8 |
| | Printing durability | 2 | 2 | 2 | 2 | 2 | 2 |
| | Surface state of coating film | A | A | A | A | A | A |
| | Ink adhesion properties | 2 | 2 | 2 | 2 | 2 | 2 |

From the results in Tables 8 to 14, it can be seen that the positive-working lithographic printing plate precursor of each Example according to the present disclosure provides a high-definition image with good development discrimination, and a lithographic printing plate to be obtained has excellent printing durability and scratch resistance.

From the results of Example 29, the results of using propyl gallate of the specific compound (a-2) are good. In addition, from the results of Examples 29 to 33, it can be seen that good results are obtained regardless of the content of the specific compound.

From the comparison of Example 29 with Examples 49, and 50 to 54, it can be seen that the use of a fluorine-based surfactant, or a siloxane-based surface conditioner, and a surfactant, and further the combined use of the siloxane-based surface conditioner (e-2), can result in particularly improved development discrimination and scratch resistance.

From the comparison of Comparative Examples 13 to 16 with each Example, it can be seen that, even in a case of a compound having a phenolic hydroxyl group in one molecule, each Example is more favorable in development discrimination, printing durability of the lithographic printing plate, and scratch resistance of the image area, as compared with the positive-working lithographic printing plate precursor having an image-recording layer consisting of a positive-working photosensitive resin composition in which a compound having no electron-withdrawing group or a compound having an electron-withdrawing group other than the specific electron-withdrawing group is used.

The entirety of the disclosures of Japanese Patent Application No. 2024-165664, filed on Sep. 24, 2024, Japanese Patent Application No. 2024-199974, filed on Nov. 15, 2024, Japanese Patent Application No. 2025-015280, filed on Jan. 31, 2025, and Japanese Patent Application No. 2025-095099, filed on Jun. 6, 2025, is incorporated into the present specification by reference.

All literatures, patent applications, and technical standards described in the present specification are incorporated in the present specification by reference to the same extent as in a case where the individual literatures, patent applications, and technical standards are specifically and individually stated to be incorporated by reference.

What is claimed is:

1. A positive-working lithographic printing plate precursor comprising:
a support; and
an image-recording layer provided on the support and consisting of a positive-working photosensitive resin composition,
wherein the positive-working photosensitive resin composition comprises:
a compound having at least one electron-withdrawing group and at least one phenolic hydroxyl group in one molecule;
an alkali-soluble resin; and
an infrared absorber, and
the electron-withdrawing group excludes a sulfonyl group.

2. The positive-working lithographic printing plate precursor according to claim 1,
wherein the electron-withdrawing group is at least one selected from the group consisting of a halogen atom, a trifluoromethyl group, a nitro group, a cyano group, an alkoxycarbonyl group, an acyloxy group, an amide group, and an alkylcarbonyl group.

3. The positive-working lithographic printing plate precursor according to claim 1,
wherein the compound having at least one electron-withdrawing group and at least one phenolic hydroxyl group in one molecule has two or more phenolic hydroxyl groups in one molecule.

4. The positive-working lithographic printing plate precursor according to claim 1,
wherein the compound having at least one electron-withdrawing group and at least one phenolic hydroxyl group in one molecule has three or more phenolic hydroxyl groups in one molecule.

5. The positive-working lithographic printing plate precursor according to claim 1,
wherein the electron-withdrawing group is an alkoxycarbonyl group or an alkylcarbonyl group.

6. The positive-working lithographic printing plate precursor according to claim 1,
wherein the compound having at least one electron-withdrawing group and at least one phenolic hydroxyl group in one molecule includes at least one selected from the group consisting of a gallic acid ester compound and a compound having a plurality of gallic acid ester moieties in the same molecule.

7. The positive-working lithographic printing plate precursor according to claim 1,
wherein the compound having at least one electron-withdrawing group and at least one phenolic hydroxyl group in one molecule is a gallic acid ester compound.

8. A positive-working lithographic printing plate precursor comprising:
a support; and
an image-recording layer provided on the support,
wherein the image-recording layer has a lower layer and an upper layer in this order from a support side, and at least one of the lower layer or the upper layer consists of a positive-working photosensitive resin composition,
the positive-working photosensitive resin composition comprises:
a compound having at least one electron-withdrawing group and at least one phenolic hydroxyl group in one molecule;
an alkali-soluble resin; and
an infrared absorber, and
the electron-withdrawing group excludes a sulfonyl group.

9. The positive-working lithographic printing plate precursor according to claim 8, further comprising:
an undercoat layer between the support and the image-recording layer.

10. The positive-working lithographic printing plate precursor according to claim 8,
wherein the lower layer consists of the positive-working photosensitive resin composition, and
the alkali-soluble resin contained in the lower layer includes at least one selected from the group consisting of an acrylic resin having a sulfonamide group in a side chain, an acrylic resin having a phenolic hydroxyl group in a side chain, and a novolac resin.

11. The positive-working lithographic printing plate precursor according to claim 8,
wherein the upper layer consists of the positive-working photosensitive resin composition,
the upper layer contains an infrared absorber and a water-insoluble, alkali-soluble resin, and the water-insoluble, alkali-soluble resin is at least one selected from the group consisting of a polyamide resin, an epoxy resin, a polyacetal resin, an acrylic resin, a methacrylic resin, a polystyrene-based resin, and a novolac-type phenolic resin, and
an interaction is formed between a polar group contained in the water-insoluble, alkali-soluble resin and the infrared absorber.

12. The positive-working lithographic printing plate precursor according to claim 9,
wherein the undercoat layer contains at least one selected from the group consisting of a phosphonic acid having an amino group, an organic phosphonic acid, an organic phosphoric acid, an organic phosphinic acid, an amino acid, and a hydrochloride of an amine having a hydroxy group.

13. The positive-working lithographic printing plate precursor according to claim 8,
wherein the upper layer further contains a polymer having a unit having a fluorinated alkyl group in a side chain.

14. The positive-working lithographic printing plate precursor according to claim 8,
wherein at least one of the upper layer or the lower layer contains a polymer having a unit represented by Formula (I), 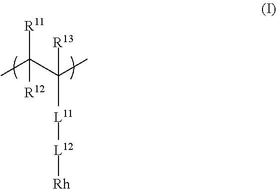
in Formula (I), R¹¹ and R¹² each independently represent a hydrogen atom or an alkyl group, R¹³ represents a hydrogen atom or a monovalent substituent, L¹¹ and L¹² each independently represent a single bond or a divalent linking group, and Rh represents a substituent containing two or more silicon atoms.

15. The positive-working lithographic printing plate precursor according to claim 14,
wherein the upper layer contains the polymer having a unit represented by Formula (I).

16. A method of preparing a lithographic printing plate, comprising, in the following order:
imagewise exposing the positive-working lithographic printing plate precursor according to claim 1; and
developing the exposed precursor with an alkali aqueous solution having a pH of 8.5 to 13.5.

17. A method of preparing a lithographic printing plate, comprising, in the following order:
imagewise exposing the positive-working lithographic printing plate precursor according to claim 8; and
developing the exposed precursor with an alkali aqueous solution having a pH of 8.5 to 13.5.
